(19) United States
(12) Patent Application Publication
(10) Pub. No.: US 2006/0189774 A1
(43) Pub. Date: Aug. 24, 2006

(54) Modifiable polyunsaturated polymers and processes for their preparation

(75) Inventors: Anbanandam Parthiban, Jurong Island (SG); Murugapillai Venugopal, Jurong Island (SG)

Correspondence Address: FOLEY & LARDNER LLP, P.O. BOX 80278, SAN DIEGO, CA, 92138-0278, US

(73) Assignee: Agency for Science, Technology and Research

(21) Appl. No.: 11/061,079

(22) Filed: Feb. 18, 2005

(51) Int. Cl. C08F 136/00

(52) U.S. Cl. 526/335

(57) ABSTRACT

The present invention relates to modifiable linear polyunsaturated polymers and processes for preparing the same comprising reacting solely at least one bifunctional nucleophilic compound with at least one α-functional unsaturated monomer. The at least one bifunctional nucleophilic compound of the invention comprises two nucleophiles independently selected from the group consisting of C, N, O, S and Se. The at least one α-functional unsaturated monomer of the invention comprises two leaving groups L¹ and L², wherein at least one of the leaving groups L¹ and L² of the at least one α-functional unsaturated monomer is part of the nonaromatic unsaturated structure C═C—C_{α}-L. The double bond of said α-functional unsaturated monomer is maintained in the polyunsaturated polymer.

### FIELD OF THE INVENTION

The present invention relates to modifiable linear polyunsaturated polymers and processes for preparing the same comprising reacting solely at least one bifunctional nucleophilic compound with at least one α-functional unsaturated monomer. The at least one bifunctional nucleophilic compound of the invention comprises two nucleophiles independently selected from the group consisting of C, N, O, S and Se. The at least one α-functional unsaturated monomer of the invention comprises two leaving groups L¹ and L², wherein at least one of the leaving groups L¹ and L² of the at least one α-functional unsaturated monomer is part of the nonaromatic unsaturated structure C═C—C_{α}-L. The double bond of said at least one α-functional unsaturated monomer is maintained in the linear polyunsaturated polymer. In some embodiments, unsaturated polymers of poly(ether)s, poly(ester)s, poly(ether ester)s, poly(amide)s, poly(imide)s, poly(tertiary amine)s, poly(tertiary amino ether)s, polyhydrocarbons, poly(sulphide)s, and poly(ketone)s can be prepared by the nucleophilic displacement reaction by using C, N, O, S and Se based nucleophiles.

### BACKGROUND OF THE INVENTION

Polymers have very wide applications and the choice of the polymer for a particular application is determined by its various properties like the glass transition temperature (T_{g}), thermal stability, chemical resistance, solvent resistance, mechanical properties etc. The basic structure of polymers requires many types of modifications in order to meet the requirements of various application areas. Such modifications are possible only when the polymer carries reactive groups which can be made use of in many ways by chemical reactions. For these reactive groups to be useful, it is important that they remain inert during polymer formation and undergo chemical reaction only when they are targeted. Such chemical reactions carried out as a post-polymerization reaction broaden the spectrum of application of base polymers enormously. Thermal stability, T_{g}, hydrophilicity, hydrophobicity, solubility, adhesion, low friction, fire resistance, etc. are some of the properties which can be affected by these chemical reactions.

Among the reactive groups which are inert under polymerizing conditions are double bonds or the unsaturated bonds particularly when conditions like high temperature, free radical initiators, UV light, etc. are avoided. The incorporation of a double bond into the polymer chain offers a wide range of possibilities. A polymer carrying the unsaturated bond in its backbone has the advantage of being easily derivatized and hence can be used either directly for reactions like crosslinking or for many other functionalization reactions. This also offers the unique advantage of forming advanced comb like or brush like structures.

By including unsaturated moieties such as maleimide terminated esters, a curable polymer can be achieved as disclosed in U.S. Pat. No. 6,706,777 B1. U.S. Pat. No. 6,605,692 B1 discloses the thermal or photochemical polymerisation of a dithiol with a diolefin. While obtaining curable ene thiol elastomers, the method comes with the disadvantage of obtaining low molecular weight oligomers.

Typical examples of commercially prepared polymers are polyesters, polyimides or polyketones.

Polyesters are prepared industrially by reacting a diol or its derivative with a dicarboxylic acid or its derivative. The reaction mixtures are heated at temperatures greater than 200° C. under vacuum in presence of a catalyst. A side reaction under these conditions, especially if an excess of diols such as ethylene glycol is used, is the formation of ethers such as diethylene glycol from two diol molecules, negatively affecting the T_{g} of the polymer. Furthermore, both high temperatures as well as polymerization catalysts lead to dark colouring of the polymer.

Polyimides are made by reacting a dianhydride with a diamine to form polyamic acids in the first step. In a subsequent step these polyamic acids undergo cyclization to yield polyimide polymers. This cyclization is performed either by a thermal or by a chemical method. The thermal method involves heating under vacuum to temperatures as high as 250° C. A major disadvantage of the use of such conditions is a reduction in molecular weight of the polyamic acid. The chemical method involves heating the polyamic acid with mixtures of tertiary amine and acetic anhydride. In both cases the polyimide formed tends to be yellow or dark in colour due to the high temperatures involved.

Polyketones are generally prepared by reacting olefins with carbon monoxide under high pressures in the presence of Pd catalysts. The polymerization normally proceeds under free radical conditions and hence no truly alternating polymer is obtained. The amount of carbon monoxide incorporation is normally lower than that of the olefin. Polar monomers incorporated in polyolefins have many positive influences on the polymer properties. Hence a process which facilitates the formation of alternating keto group formation is preferred.

Polyimides and polyesters are condensation type polymers, in which, as the polymerization progresses, some small molecules are eliminated. The presence of these small molecules generally affects the degree of polymerization. Thus in order to increase the molecular weight of the final polymer these liberated small molecules need to be continuously removed from the reaction mixture. As these are non-volatile side products, it becomes necessary to further increase the reaction temperature. Hence a process which results in inert byproducts would be desirable.

A further class of polymers are thermoplastic isocyanurate polymers. Such polymers and cured polymers thereof may, for example, be obtained by reacting the sodium salt of the tri-functional compound isocyanuric acid, a mono-functional compound and a dihalo compound as for instance xylyl dichlorides, bis(2-chloroethyl)ether or 1,4-dichlorobutene (see G.B. Patent 975,707). Mono-functional compounds like allylchloride, methallylchloride, or chloroacetonitrile are required to be present in the reaction mixture according to this patent as capping agents and added to the reaction together with the dihalo compound in order to obtain polymers with favourable processability characteristics and to block the formation of a complex cross-linked structure.

The above summarized methods of polymer formation of polyesters, polyimides or polyketones thus have several disadvantages in common. They require high amounts of energy for heating, resulting in economic costs. High temperatures lead to an undesirable darkening of the reaction products, which is in many markets undesirable due to aesthetical considerations. The resulting polymers are furthermore not easily further derivatizable or curable by subsequent chemical reactions.

Accordingly, in one aspect, it is an object of the present invention to provide an alternative process for preparing modifiable polyunsaturated polymers. It is another object of the invention to provide a process for preparing such polymers under mild conditions. In a different aspect, it is an object of the present invention to provide modifiable polyunsaturated polymers obtainable by an alternative process. Another object of the invention is to provide modifiable polyunsaturated polymers obtainable by a process which may be performed under mild reaction conditions.

### SUMMARY OF THE INVENTION

The present invention relates to modifiable linear polyunsaturated polymers and processes for preparing the same, comprising reacting solely at least one bifunctional nucleophilic compound with at least one α-functional unsaturated monomer. The at least one bifunctional nucleophilic compound of the invention comprises two nucleophiles independently selected from the group consisting of C, N, O, S and Se. The at least one α-unsaturated monomer of the invention comprises two leaving groups L¹ and L², wherein at least one of the leaving groups L¹ and L² of the at least one α-unsaturated monomer is part of the nonaromatic unsaturated structure C═C—C_{α}L. The double bond of said at least one α-functional unsaturated monomer is maintained in the linear polyunsaturated polymer.

The polyunsaturated polymers obtained in this reaction do not contain branches in their polymer backbone. Such branches may however be introduced into the backbone after the preparation of the inventive polymers with the help of cross-linking agents.

These and other features of the invention will be better understood in light of the following drawings and detailed description.

### BRIEF DESCRIPTION OF THE DRAWINGS

FIG. 1 shows a two-part exemplary scheme for possible preparations of modifiable linear polyunsaturated polymers starting from an α-functional unsaturated monomer and bifunctional nucleophilic compounds, wherein both leaving groups of the α-functional unsaturated monomer are separated from a nonaromatic carbon-carbon double bond by one carbon atom. For convenience, the α-functional unsaturated monomer has been abbreviated as 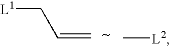
wherein ‘˜’ shall represent the various structural options that the α-unsaturated monomer may contain with respect to the position of the leaving groups. All examples shown are nucleophilic displacement reactions of the leaving groups of the α-functional unsaturated monomer by nucleophiles comprised in the functional groups of the shown various bifunctional nucleophilic compounds. FIG. 1A depicts exemplary reactions leading to modifiable linear polyunsaturated polyethers, polyesters, polyether esters, polymeric tertiary amines, polyamides and polyimides. R²⁰ to R²⁵ may be aliphatic, alicyclic, aromatic or arylaliphatic moieties. R²⁰ to R²⁵ may also contain other polar, non-polar, saturated or unsaturated groups. FIG. 1B depicts exemplary reactions leading to modifiable linear polyunsaturated polytertiary amino ethers, polysulfides, polyhydrocarbons and polyketones. R²⁶ to R³⁰ may be aliphatic, alicyclic, aromatic or arylaliphatic moieties. R²⁶ to R³⁰ may also contain other polar, non-polar, saturated or unsaturated groups.

FIG. 2A depicts a subselection of the exemplary scheme of FIG. 1A for possible preparations of modifiable linear polyunsaturated polymers, wherein the α-functional unsaturated monomer is of the structure L¹-CH₂—CH═CH—CH₂-L².

FIG. 2B shows, in accordance with FIG. 1B, an exemplary scheme for further possible preparations of modifiable linear polyunsaturated polymers starting from a α-functional unsaturated monomer L¹-CH₂—CH═CH—CH₂-L² and bifunctional nucleophilic compounds.

FIG. 3A shows a subselection of the exemplary scheme of FIG. 1A for possible preparations of modifiable linear polyunsaturated polymers, wherein the α-functional unsaturated monomer is of the structure L¹-CR¹H—C(CR⁵H-L²)=CR³R⁷. R¹, R³, R⁵ and R⁷ may be an independently selected aliphatic or cycloaliphatic alkyl group, an aromatic or arylaliphatic group, H or—as long as L¹ and L² are different from F (fluorine)-F.

FIG. 3B shows, in accordance with FIG. 1B, an exemplary scheme for possible further preparations of modifiable linear polyunsaturated polymers starting from the α-functional unsaturated monomer L¹-CR¹H—C(CR⁵H-L²)═CR³R⁷ and bifunctional nucleophilic compounds.

FIG. 4 depicts examples of suitable α-functional unsaturated monomers, wherein at least one of the leaving groups L¹ and L² of the at least one α-functional unsaturated monomer is part of the nonaromatic unsaturated structure C═C—C_{α}-L. In the shown examples both leaving groups of the α-functional unsaturated monomer are separated from a non aromatic carbon-carbon double bond by one carbon atom. The monomers are represented by their structural formula and their Chemical Abstracts registration number.

FIG. 5 depicts examples of suitable bifunctional nucleophilic compounds for the reaction with α-functional unsaturated monomers, wherein at least one leaving group of the α-functional unsaturated monomer is separated from a non aromatic carbon-carbon double bond by one carbon atom. The bifunctional nucleophilic compounds are represented by their structural formula and their Chemical Abstracts registration number. FIG. 5A shows examples of suitable diols, FIG. 5B shows examples of suitable diamines, FIG. 5C shows examples of suitable dicarboxylic acids, and FIG. 5D shows examples of suitable dicarboxylic acid anhydrides. FIG. 5E shows two examples of suitable dialdehydes. Such dialdehydes are preferably used in form of their respective dithioacetals, as shown under the respective dialdehydes. FIG. 5F shows examples of suitable dithiols, FIG. 5G shows examples of suitable diamides shows examples of suitable diimides, FIG. 51 shows examples of suitable difunctional 1,3-dithianes, FIG. 5J shows examples of suitable diselenols, FIG. 5K shows examples of suitable bifunctional organo metal reagents, FIG. 5L shows examples of suitable bifunctional organo boronic acids, FIG. 5M shows examples of suitable hydroxy acids and FIG. 5N shows further examples of suitable bifunctional nucleophilic compounds.

FIG. 6A depicts examples of additional compounds that may be added to the linear polyunsaturated polymer obtained by the present invention, in order to introduce branches into the polymer backbone. It should be noted that these compounds are not suitable as monomers for the polymerisation reaction of the present invention as such. The examples shown are α-functional unsaturated monomers comprising three or four leaving groups. The monomers are represented by their structural formula and their Chemical Abstracts registration number.

FIG. 6B depicts further examples of additional compounds that may be added to the linear polymers of the invention, in order to introduce branches into the polymer backbone. It should again be noted that these compounds are not suitable as monomers for the polymerisation reaction of the present invention as such. The examples shown are nucleophilic compounds comprising three or four nucleophiles. The monomers are represented by their structural formula and their Chemical Abstracts registration number.

### DETAILED DESCRIPTION OF THE INVENTION

The present invention is based on the surprising finding that aliphatic or alicyclic unsaturated compounds that contain two leaving groups in the α-position of a double bond are molecules with sufficiently high reactivity to yield high molecular weight polymers already at significantly lower temperatures than generally used for polymerization reactions. Accordingly, the nucleophilic displacement of suitable leaving groups such as halogens from α-functional unsaturated compounds can be performed under mild reaction conditions. Furthermore, this process offers the advantage of producing derivatizable or functionalizable linear polymers, which are polyunsaturated polymers.

As already indicated above, the leaving groups of the α-functional unsaturated monomers used in the present invention are separated from a non aromatic carbon-carbon double bond by one carbon atom. Such a carbon atom, which is directly linked to a carbon-carbon double bond, is termed the α-carbon. A leaving group that is covalently linked to this α-carbon is also said to be in the α-position. The position of the leaving groups within the α-functional unsaturated monomer may thus be represented by structure I 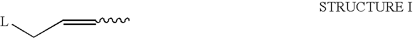
wherein L represents a respective leaving group. Hence, the leaving groups L¹ and L² are typically located in an allylic position. Apart from the above cited preparation of isocyanurate polymers, unsaturated compounds with two leaving groups in an α-position have so far been used as crosslinking agents and as initiators of polymerisation. An available method of radically cross linking of an existing polymer involves the use of allyl substituted quaternary ammonium salts (see U.S. Pat. No. 6,646,083 B2). Diphenyl sulphone crosslinking compounds have been prepared by reacting 1,4-dihalobutene and 4,4′-dihydroxydiphenyl sulfones (see U.S. Pat. No. 6,037,308). Allyl-type dihalides have been used as initiators for a cationic ring-opening polymerisation of heterocyclic monomers (see U.S. Pat. No. 5,164,477).

The α-functional unsaturated monomers used in the present invention may contain various additional moieties as long as these moieties do not prevent the occurrence of a polymerisation reaction. They may furthermore contain additional functional groups as long as these are not able to participate in the polymerisation reaction under the reaction conditions selected (cf. for example also para 76 below). The non aromatic carbon-carbon double bond(s), to which a leaving group is in the α-position, may be part of a linear or a cyclic nonaromatic structure. Hence, linear or cyclic moieties may be incorporated into the polymer backbone. The term “linear polyunsaturated polymer” as used herein does therefore not refer to the presence or absence of linear moieties in the polymer, but rather to a straight polymer backbone that does not contain branches.

The respective non aromatic carbon-carbon double bond of the α-functional unsaturated monomers may furthermore provide the α-position for both or for only one of the leaving groups. Hence, where only one of the leaving groups is in an α-position to a respective carbon-carbon double bond, the α-functional unsaturated monomer contains, for instance, two such carbon-carbon double bonds. Where both leaving groups, which take part in the polymerisation reaction, are in the α-position to the same respective carbon-carbon double bond, the α-functional unsaturated monomer however contains only one such carbon-carbon double bond. However, it should be understood that the α-functional unsaturated monomer may in addition to the one or two carbon-carbon double bonds to which the leaving groups are in the α-position, also contain additional, for instance, third and fourth, internal carbon-carbon double bonds. Any number of these additional double bonds may be in conjugation with the one or two carbon-carbon double bonds to which the leaving groups are in the α-position. These additional double bonds may also be in conjugation with further double bonds containing heteroatoms or with aromatic moieties.

Where the one or two non aromatic carbon-carbon double bonds, to which the leaving groups are in the α-position, are part of a linear structure, typical underlying structures of a suitable α-functional unsaturated compound may therefore include, but are not limited to, the following: 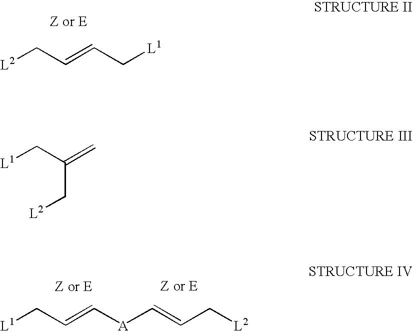
wherein L¹ and L² represent the respective independently selected leaving groups, and A in structure IV may be (i) absent, (ii) a heteroatom selected from the group N, O, S, Se and Si and (iii) a hydrocarbyl group selected from the group consisting of aliphatic, cycloaliphatic, aromatic, and arylaliphatic, containing 0 to about 3 heteroatoms independently selected from the group N, O, S, Se and Si.

Where the one or two non aromatic carbon-carbon double bonds, to which the leaving groups are in the α-position, are part of a cyclic structure, typical underlying structures of a suitable α-functional unsaturated compound may include, but are not limited to, the following: 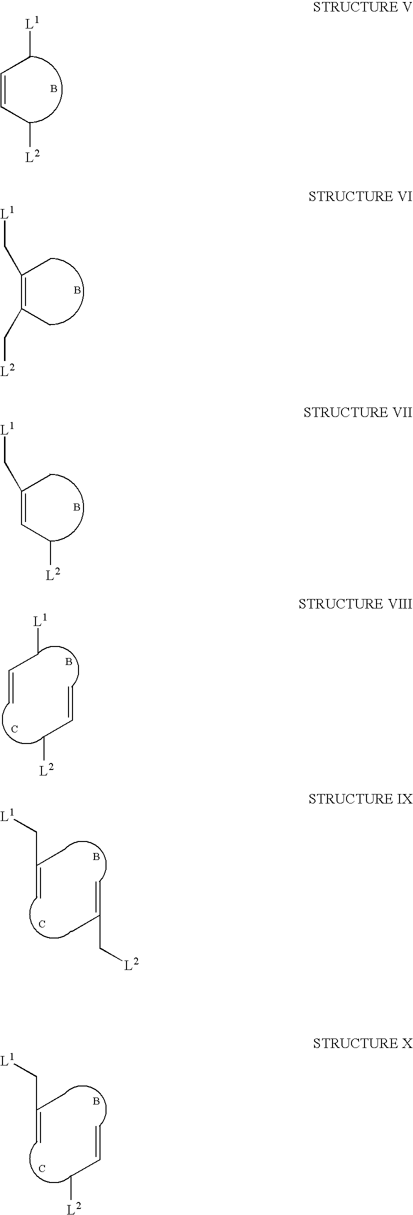
wherein B and C are an aliphatic bridge containing 1 to about 12 carbon atoms, completing a nonaromatic ring.

In accordance with the above disclosure, examples of nonaromatic rings, which the aliphatic bridge ‘B’ in structures V to VII may complete, include, but are not limited to, cyclopentene, cyclohexene, cycloheptene cyclooctene, cyclononene, cyclodecene, cyclododecene or cyclotetradecene. As indicated above, the aliphatic bridges may also contain additional unsaturated bonds. Further examples of non-aromatic rings that the aliphatic bridge ‘B’ in structures V to VII may thus complete, and which likewise both aliphatic bridges ‘B’ and ‘C’ in structures VIII to X may complete, include, but are not limited to, 1,5-cyclooctadiene, 1,6-cyclodecadiene, 1,3,6-cyclodecatriene, 1,6-cycloundecadiene, 1,3,6-cycloundecatriene, 1,7-cyclododecadiene, 1,7-cyclotridecadiene, 1,7-cyclotetradecadiene, 1,3,9-cyclotetradecatriene, 1,8-cyclopentadecadiene, 1,5-cyclohexadecadiene or 1,8-cyclohexadecadiene. The aliphatic bridges ‘B’ and ‘C’ in structures V to VIII and structures VIII and X, respectively, may furthermore contain various side chains, which may additionally be connected back to atoms of the aliphatic bridge, so as to form one or more additional bridges. These side chains may for instance comprise aliphatic, cycloaliphatic, aromatic or arylaliphatic moieties.

The term “aliphatic” means, unless otherwise stated, a straight or branched hydrocarbon chain, which may be saturated or mono- or polyunsaturated. An unsaturated aliphatic group contains one or more double and/or triple bonds. The branches of the hydrocarbon chain may include linear chains as well as non-aromatic cyclic elements. The hydrocarbon chain, which may, unless otherwise stated, be of any length, and contain any number of branches. Both the main chain as well as the branches may furthermore contain heteroatoms as for instance N, O, S, Se or Si.

The term “alicyclic” means, unless otherwise stated, a nonaromatic cyclic hydrocarbon moiety, which may be saturated or mono- or polyunsaturated. The cyclic hydrocarbon moiety may be substituted with nonaromatic cyclic as well as chain elements. The main chain of the cyclic hydrocarbon moiety may, unless otherwise stated, be of any length and contain any number of non-aromatic cyclic and chain elements. Both the cyclic hydrocarbon moiety and the cyclic and chain substituents may furthermore contain heteroatoms, as for instance N, O, S, Se or Si.

The term “aromatic” means, unless otherwise stated, a planar cyclic hydrocarbon moiety of conjugated double bonds, which may be a single ring or include multiple fused or covalently linked rings. The main chain of the cyclic hydrocarbon moiety may, unless otherwise stated, be of any length and contain any number of heteroatoms, as for instance N, O and S.

By the term “arylaliphatic” is meant a hydrocarbon moiety, in which one or more aryl groups are attached to or are substituents on one or more aliphatic groups. Thus the term “arylaliphatic” includes for instance hydrocarbon moieties, in which two or more aryl groups are connected via one or more aliphatic chain or chains of any length, for instance a methylene group.

Each of the terms “aliphatic”, “alicyclic”, “aromatic” and “arylaliphatic” as used herein is meant to include both substituted and unsubstituted forms of the respective moiety. Substituents my be any functional group, as for example, but not limited to, amino, amido, azido, carbonyl, carboxyl, cyano, isocyano, dithiane, halogen, hydroxyl, nitro, organometal, organoboron, seleno, silyl, silano, sulfonyl, thio, thiocyano, trifluoromethyl sulfonyl, p-toluenesulfonyl, bromobenzenesulfonyl, nitrobenzenesulfonyl, and methanesulfonyl.

Additional moieties of the α-functional unsaturated monomer may be located at any position within the monomer as long as this location does not prevent the occurrence of a polymerisation reaction. An example of a suitable position are the α-carbon atoms. Where an α-carbon atom carrying a leaving group of for instance structures II or III is substituted with one aliphatic or aromatic moiety, the leaving group at the respective α-carbon atom is a secondary-substituted leaving group. Where an α-carbon atom carrying a leaving group of for instance structures V or VIII is substituted with one aliphatic or aromatic moiety, the leaving group at the respective α-carbon atom is a tertiary-substituted leaving group. Persons skilled in the art will be aware of the fact that a primary-substituted leaving group generally shows a higher reactivity than a secondary-substituted leaving group, while a tertiary-substituted leaving group possesses a still lower reactivity. However, the reactivity of the respective leaving group also depends on the nature of the moiety linked to the α-carbon atom. The presence of an aromatic moiety will for instance increase the reactivity beyond that of a primary-substituted leaving group.

Typical embodiments of α-functional unsaturated compounds of structure II may thus for instance be represented by the formula:
L¹-CR¹R²—CR³═CR⁴—CR⁵R⁶-L²
wherein L¹ and L² represent the respective independently selected leaving groups, R¹ to R⁶ may be H, an independently selected aliphatic or cycloaliphatic alkyl group, an aromatic or arylaliphatic group, H or—as long as L¹ and L² are different from F (fluorine)-F.

Typical embodiments of α-functional unsaturated compounds of structure III may for instance be represented by the formula:
L¹-CR¹R²—C(CR⁵R⁶-L²)=CR³R⁷
wherein L¹ and L² represent the respective independently selected leaving groups; R¹, R², R³, R⁵, R⁶ and R⁷ may be H, an independently selected aliphatic or cycloaliphatic alkyl group, an aromatic or arylaliphatic group, or—as long as L¹ and L² are different from F (fluorine)-F.

Typical embodiments of α-functional unsaturated compounds of structure IV may for instance be represented by the formula:
L¹-CR¹R²—CR³═CR⁴-A-CR⁸═CR⁹—CR⁵R⁶-L²
wherein L¹ and L² represent the respective independently selected leaving groups; R¹ to R⁶, R⁸ and R⁹ may be H, an independently selected aliphatic or cycloaliphatic alkyl group, an aromatic or arylaliphatic group, or—as long as L¹ and L² are different from F (fluorine)-F; and A may be (i) absent, (ii) a heteroatom selected from the group N, O, S, Se and Si and (iii) a hydrocarbyl group selected from the group consisting of aliphatic, cycloaliphatic, aromatic, and arylaliphatic, containing 0 to about 3 heteroatoms independently selected from the group N, O, S, Se and Si.

Typical embodiments of α-functional unsaturated compounds of structure V may for instance be represented by the formula: 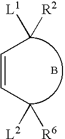
wherein L¹ and L² represent the respective independently selected leaving groups; R² and R¹ may be H, an independently selected aliphatic or cycloaliphatic alkyl group, an aromatic or arylaliphatic group, or—as long as L¹ and L² are different from F (fluorine)-F; and B is an aliphatic bridge containing 1 to about 12 carbon atoms, completing a nonaromatic ring.

Typical embodiments of α-functional unsaturated compounds of structure VI may for instance be represented by the formula: 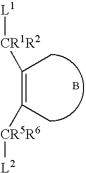
wherein L¹ and L² represent the respective independently selected leaving groups; and R¹, R², R⁵ and R⁶ may be H, an independently selected aliphatic or cycloaliphatic alkyl group, an aromatic or arylaliphatic group, or—as long as L¹ and L² are different from F (fluorine)-F, and B is an aliphatic bridge containing 1 to about 12 carbon atoms, completing a non-aromatic ring.

Typical embodiments of α-functional unsaturated compounds of structure VII may for instance be represented by the formula: 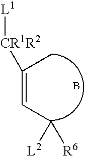
wherein L¹ and L² represent the respective independently selected leaving groups; R¹, R² and R⁶ may be H, an independently selected aliphatic or cycloaliphatic alkyl group, an aromatic or arylaliphatic group, or—as long as L¹ and L² are different from F (fluorine)-F; and B is an aliphatic bridge containing 1 to about 12 carbon atoms, completing a non-aromatic ring.

Typical embodiments of α-functional unsaturated compounds of structure VIII may for instance be represented by the formula: 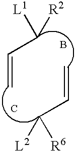
wherein L¹ and L² represent the respective independently selected leaving groups; R² and R⁶ may be H, an independently selected aliphatic or cycloaliphatic alkyl group, an aromatic or arylaliphatic group, or—as long as L¹ and L² are different from F (fluorine)-F; and B and C are an aliphatic bridge containing 1 to about 12 carbon atoms, completing a nonaromatic ring.

Typical embodiments of α-functional unsaturated compounds of structure IX may for instance be represented by the formula: 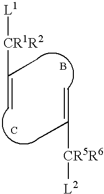
wherein L¹ and L² represent the respective independently selected leaving groups; R¹, R², R⁵ and R⁶ may be H, an independently selected aliphatic or cycloaliphatic alkyl group, an aromatic or arylaliphatic group, or—as long as L¹ and L² are different from F (fluorine)-F; and B and C are an aliphatic bridge containing 1 to about 12 carbon atoms, completing a nonaromatic ring.

Typical embodiments of α-functional unsaturated compounds of structure X may for instance be represented by the formula: 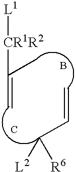
wherein L¹ and L² represent the respective independently selected leaving groups, R¹, R² and R⁶ may be H, an independently selected aliphatic or cycloaliphatic alkyl group, an aromatic or arylaliphatic group, or—as long as L¹ and L² are different from F (fluorine)-F; and B and C are an aliphatic bridge containing 1 to about 12 carbon atoms, completing a nonaromatic ring.

If one or more heteroatoms are present in any of R¹ to R⁹, they may be part of any functional group as long as the respective group does not participate in the polymerisation reaction under the selected reaction conditions and does not prevent the occurrence of a polymerisation reaction. If desired, α-functional unsaturated compounds may for example contain functional groups that decelerate the polymerisation reaction. The selection of functional groups of the reactants may as an other example also take the object into account, to minimize or completely avoid any interference with the polymerisation reaction.

Where the two α-carbon atoms, i.e. the carbon atom that separate the respective leaving groups of the α-functional unsaturated monomer from a non aromatic carbon-carbon double bond, share the same double bond, they may take various positions with respect to the double bond in a structure of the form C═C—C_{α}-L. They may be located either in a geminal position as in structure III or in a vicinal position as for instance in structure II. In the latter case the nonaromatic double bond of the α-functional unsaturated monomer of structures II and IV may be both in the trans-(E-) or cis-(Z-) configuration. Generally, compounds with a trans-configuration should be expected to show higher reaction rates than those of the respective cis-configuration, however, compounds with a cis-configuration will likewise undergo a polymerisation reaction. While no particular circumstances require the presence of a cis-configuration in structures V and VI as shown above, the ring size of a respective α-functional unsaturated monomer may not allow for a trans-configuration.

Where the two α-carbon atoms are in a geminal position as in structure III, there may in some embodiments be no trans- or cis-configuration. In case that R³ and/or R⁷ differ from H (cf the respective formula in paragraph 39), however, relative configurations, e.g. Z- or E- in relation to one of the leaving groups, may be distinguished. Compounds with suitable moieties in both configurations, e.g. both Z- and E- in relation to X, will provide monomers suitable for a polymerisation reaction.

Where the two α-carbon atoms that separate the respective leaving groups from the non aromatic carbon-carbon double bond do not share the same double bond, they may nevertheless be in a trans-(E-) or a cis-(Z-) configuration with respect to the nonaromatic double bond in relation to other moieties of the α-functional unsaturated monomer. For example in structure IV trans- and a cis-configurations are possible for both carbon-carbon double bonds, as indicated by ‘Z or E’. All four possible configurations of potential α-functional unsaturated monomers will provide monomers suitable for a polymerisation reaction. While no particular circumstances require the presence of a cis-configuration in structures VII and VIII as shown above, the ring size of a respective α-functional unsaturated monomer may not allow for a trans-configuration.

Leaving groups L¹ and L² may be different or identical. They may be any suitable leaving group familiar to those skilled in the art, which can be displaced in nucleophilic substitution reactions. Examples include, but are not limited to, chloride, fluoride, bromide, iodide, cyano-, thiocyano-, trifluoromethyl sulfonyl-, p-toluenesulfonyl-, bromobenzenesulfonyl-, nitrobenzenesulfonyl-, methanesulfonyl- or azido-groups. Furthermore, leaving groups with electron accepting character will generally result in accelerated polymerisation rates compared to electron donating groups. Nevertheless, leaving groups of both electron accepting and donating character may be selected as long as they are suitable as leaving groups in terms of not preventing the occurrence of a polymerisation reaction.

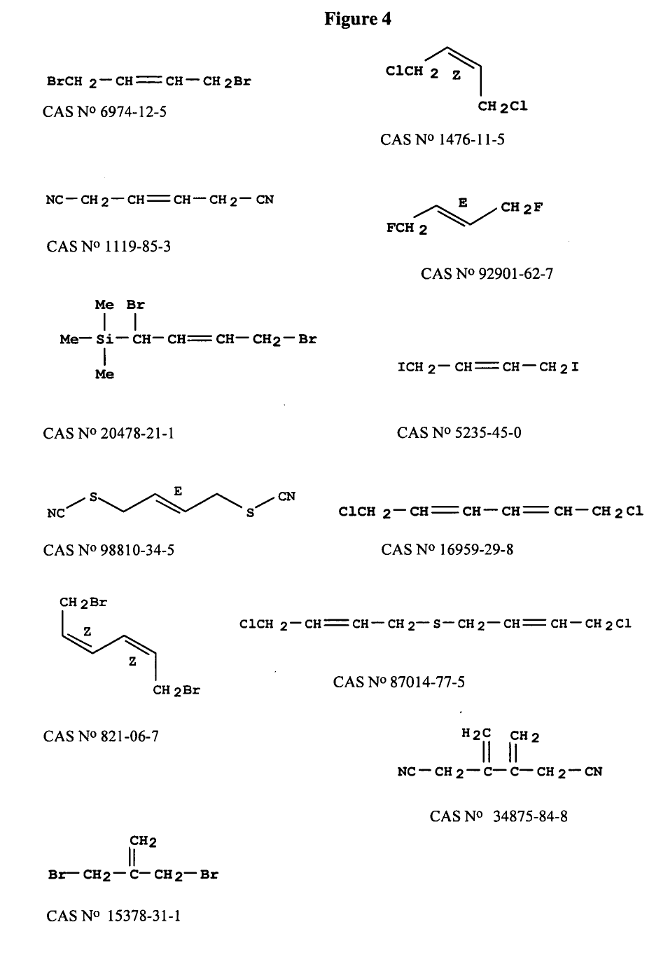

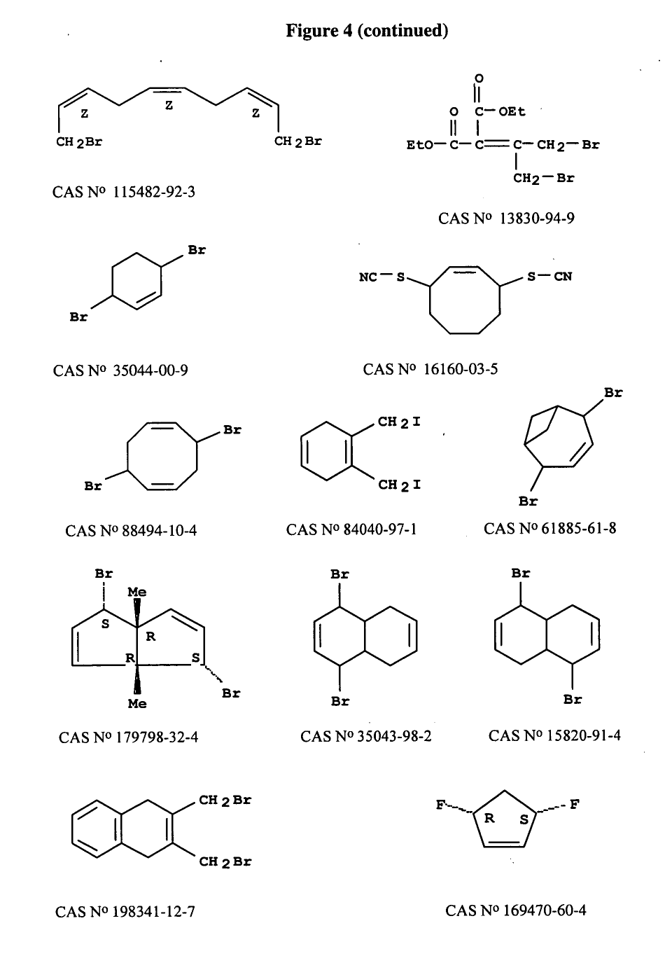

Examples of α-functional unsaturated compounds that may be used, include, but are not limited to, 1,4-dibromo-2-buten, 1,4-dichloro-2-buten, 3-hexenedinitrile, 1,4-difluoro-2-buten, 3-(1,4-dibromo-2-butenyl)trimethyl-silane, 1,4-diiodo-2-buten, 1,4-dithiocyanato-2-butene, 1,11-dibromo-2,9-undecadiene, 1,10-dibromo-2,8-decadiene, 1,9-dichloro-2,7-nonadiene, 1,12-dibromo-2,10-dodecadiene, 1,6-dichloro-2,4-hexadiene, 1,6-dibromo-2,4-hexadiene, 1,1′-thiobis[4-chloro-2-butene], 3,4-dimethylene-hexanedinitrile, 3-bromo-2-(bromomethyl)-1-propene, 1,10-dibromo-2,5,8-decatriene, [2-bromo-1-(bromomethyl)ethylidene]-malonic acid diethyl ester, 3,6-dibromo-1-cyclohexene, 2-cycloocten-1,4-ylene-thiocyanic acid ester, 3,7-dibromo-1,5-cyclooctadiene, 1,2-bis(iodomethyl)-1,4-cyclohexadiene, 2,5-dibromo-bicyclo[4.1.1]oct-3-ene, 1,4-dibromo-1,3a,4,6a-tetrahydro-3a,6a-dimethyl-pentalene, 1,4-dibromo-1,4,4a,5,8,8a-hexahydro-naphthalene, 1,5-dibromo-1,4,4a,5,8,8a-hexahydro-naphthalene, 2,3-bis(bromomethyl)-1,4-dihydro-naphthalene, and 3,5-difluoro-cyclopentene. These examples are illustrated by structural formulas in FIG. 4.

If more than one α-functional unsaturated monomer is used in the reaction with the bifunctional nucleophilic compound(s), any suitable combination in any ratio may be chosen. The selection may, for example, be made in order to avoid the occurrence of unwanted side reactions between the two or more α-functional unsaturated monomers. Although any combination of two or more α-functional unsaturated monomers with respect to relative reactivity, when compared to each other, may be used in the present invention, it should be considered that reactivity differences may affect the composition of the polymer product (cf. also e.g. para 94 et sqq.).

The nucleophilic compound or compounds, which react with the α-functional unsaturated monomer and which may thus be termed the nucleophilic monomer, may be any suitable compound comprising two nucleophiles. Such nucleophiles, also termed nucleophilic centers, may be any suitable Lewis base that is able to attack in a nucleophilic manner at an allylic carbon center. In particular, suitable nucleophiles are able to displace the leaving groups of the α-functional unsaturated compound(s), such as for instance chloride, fluoride, bromide, iodide, cyano or thiocyano (supra), for which the nucleophilicity order published by Edwards and Pearson (J. A. Chem. Soc., 84, (1962), 1, 16-24) may serve as a reference.

The term “bifunctional nucleophilic compound” as used herein means that the nucleophilic compound has two nucleophilic centers that can each undergo a reaction under the chosen reaction conditions. Accordingly, the nucleophilic compound or compounds used in the invention may comprise more than two nucleophilic centers, of which any nucleophilic center exceeding the number of two, i.e. the third, fourth etc., may for example be masked by a protective group. The nucleophilic compound(s) may furthermore or alternatively contain additional unmasked nucleophiles that are not reactive under the selected reaction conditions (cf. e.g. para 77 et sqq.).

The nucleophilic centers of the one or more bifunctional nucleophilic compound may include C, N, O, S and Se based nucleophiles. Examples of functional groups providing a carbon nucleophile, include, but are not limited to, organometal-, organoboron-, dithiol protected aldehyde-, and dithiane-groups. Organometal groups are for instance organomagnesiumchloride-, such as the well known Grignard-reagents, organomercury-, organozincchloride-, organolithium- or organopotassium-groups. Organoboron groups are for instance organoboronic acids, organoboronate esters, or organoboranes. Examples of functional groups that contain a nitrogen nucleophile, include, but are not limited to, amino- or amido-groups. Examples of functional groups that provide an oxygen nucleophile, include, but are not limited to, carboxyl- or hydroxyl-groups. A functional group that provides a sulfur nucleophile is for instance the thio- (also termed thiol-) group. A functional group that provides a selenium nucleophile is for instance the seleno- (also termed selenol-) group.

The nucleophilic compound(s) may be of any structure that allows both nucleophiles of the molecule to undergo a reaction with the α-functional unsaturated monomer. Suitable nucleophilic compounds may be represented by the general formula:
Nu¹-R¹⁰-Nu²
wherein Nu¹ and Nu² are functional groups comprising nucleophiles, and R may be an aliphatic or cycloaliphatic alkyl group, an aromatic or arylaliphatic group. R¹⁰ may furthermore contain additional functional groups as long as these are not able to participate in the polymerisation reaction under the reaction conditions selected (supra). In some embodiments, the bifunctional nucleophilic compound(s) may be low molecular weight compounds with R¹⁰ having a chain length of 0 to about 20 main chain atoms, or 0 to about 30 or 0 to about 40 main chain atoms. However, the bifunctional nucleophilic compound(s) are by no means limited to a certain main chain length. In other embodiments the nucleophilic compound(s) may thus also be macromolecules, as explained further below. As an example, suitable diols include hydroxyl terminated polydimethyl siloxanes or polydiphenyl siloxanes, which may in some embodiments be selected of having 0 to about 200 main chain atoms in R¹⁰, in other embodiments of having 0 to about 2000 main chain atoms in R¹⁰.

Typical, but not limiting examples of such nucleophilic compounds comprising two nucleophiles may be illustrated by structural formulas such as the following: 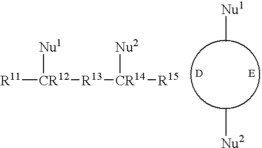
wherein (a) Nu¹ and Nu² are functional groups providing nucleophiles, (b) R¹¹, R¹³ and R¹⁵ may, independently of one another, be an aliphatic or cycloaliphatic alkyl group, an aromatic or arylaliphatic group, of which R¹³ may be absent, and of which R¹¹ and R¹⁵ may furthermore be H or F (fluorine), (c) R¹² and R¹⁴ may be H or F, and (d) D and E are an aliphatic, cycloaliphatic, aromatic or arylaliphatic bridge containing 1 to about 12 carbon atoms, completing a non-aromatic or an aromatic ring, comprising 0 to about 3 heteroatoms.

The two reactive nucleophiles or nucleophilic centers of the nucleophilic compound(s) used in the present invention for reacting with the α-functional unsaturated monomer(s) may be identical or different. Where the nucleophiles of the nucleophilic compound(s) are identical, the corresponding functional groups comprising the nucleophiles may likewise be identical. Examples of compounds with identical nucleophiles thus include, but are not limited to, diols, dicarboxylic acids, dicarboxylic acid anhydrides, diamides, dialdehydes as protected by dithioacetals, diamines, dithiols, difunctional dithianes, difunctional organoboronic acids or dimetallic compounds.

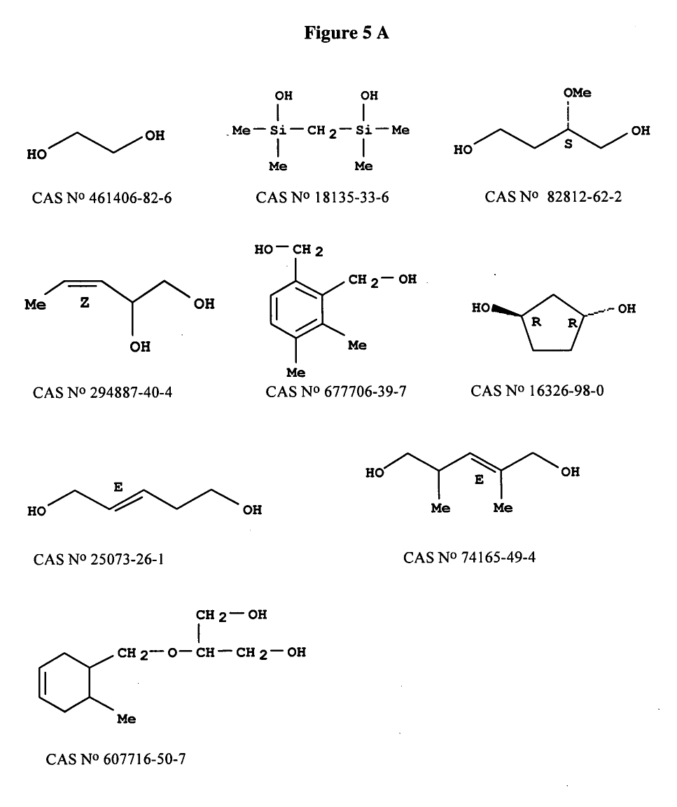

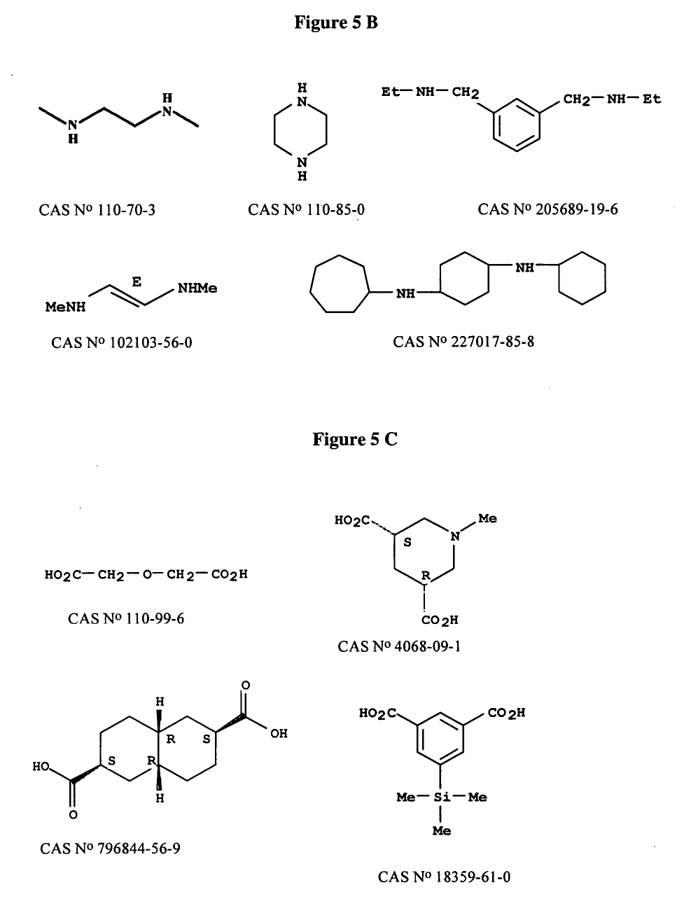

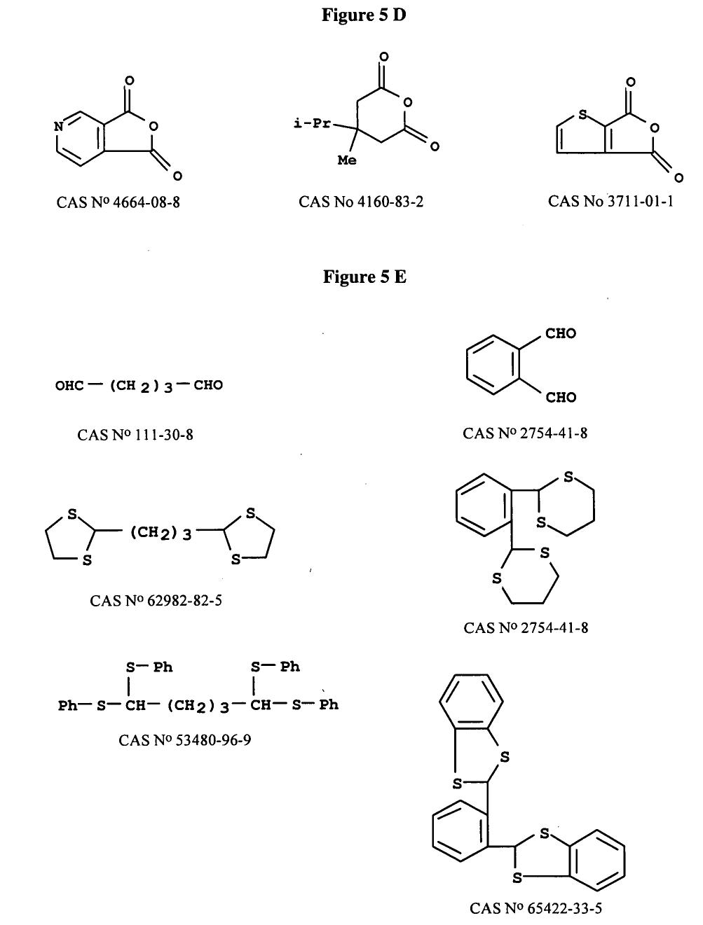

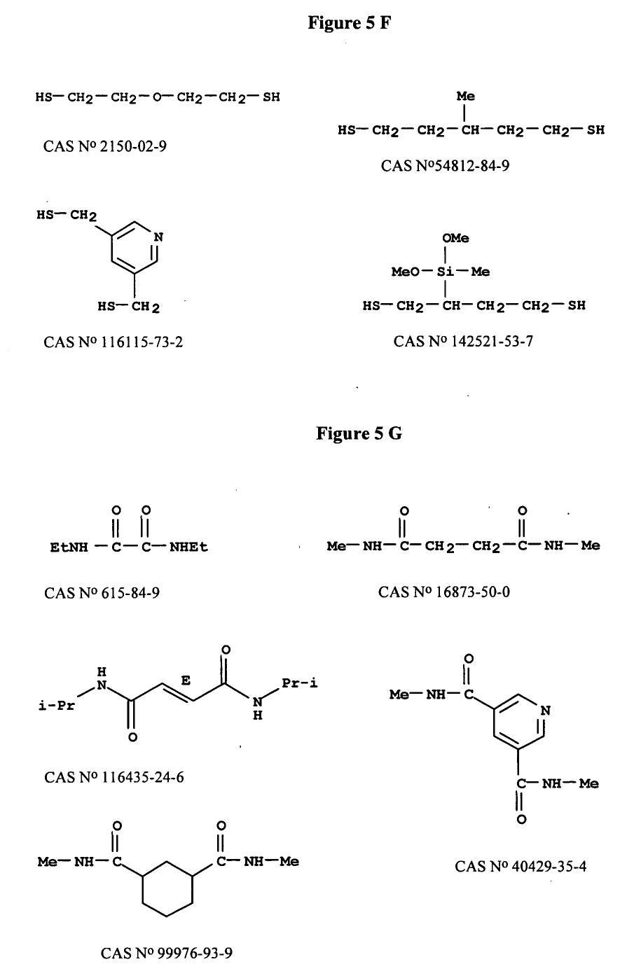

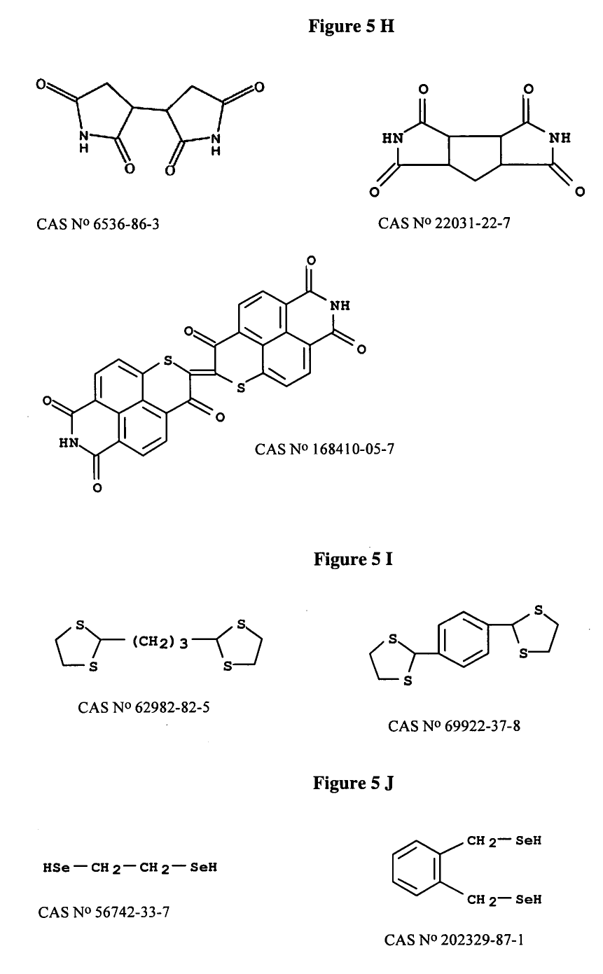

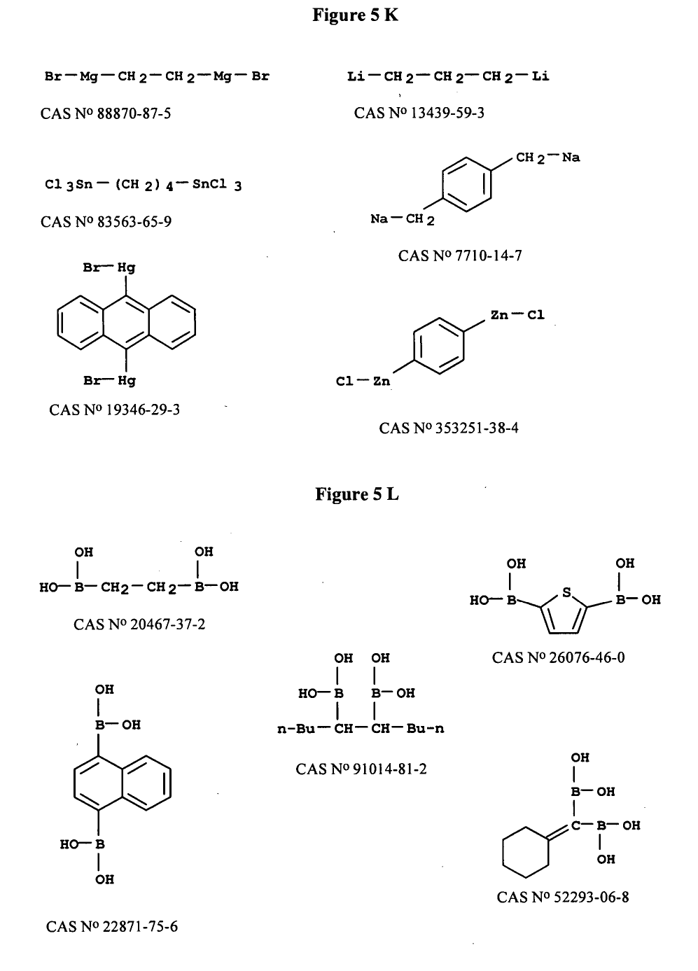

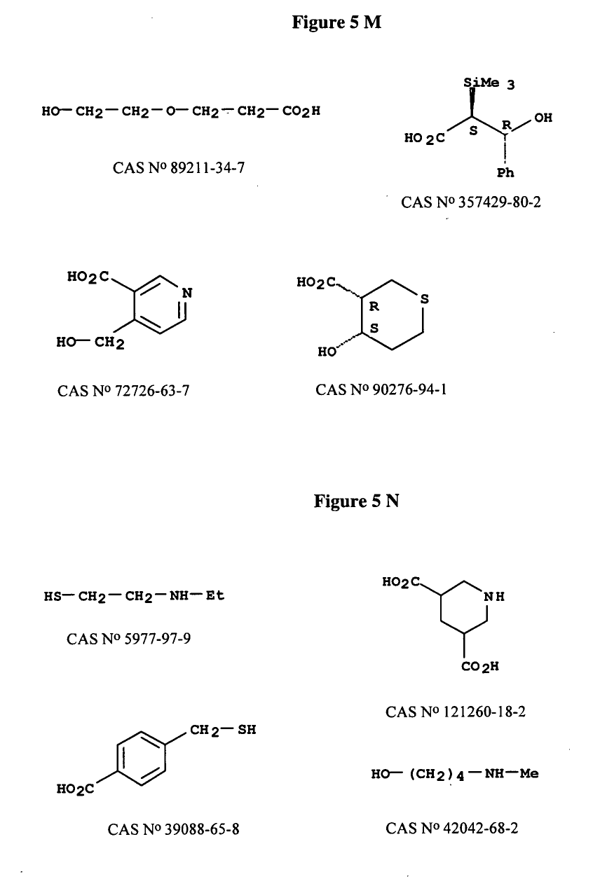

Examples of suitable diols include, but are not limited to, 1,2-ethanediol, 1,4-butanediol, 1,12-dodecanediol, bis(hydroxydimethylsilyl)methane, 2-methoxy-1,4-butanediol, 3-pentene-1,2-diol, 2,4-dimethyl-2-pentene-1,5-diol, 3,4-dimethyl-1,2-benzenedimethanol, 1,3-cyclopentanediol, 1,4-cyclohexanediol, 1,4-cyclohexanedimethanol, 2-(hydroxylmethyl)-2-methyl-1,3-propanediol, 2-pentene-1,5-diol, 2H-thiopyran-2,5-diol, tetrahydro-2H-thiopyran-2,6-dimethanol, and 2-[(6-methyl-3-cyclohexen-1-yl)methoxy]-1,3-propanediol. A number of these examples are illustrated by structural formulas in FIG. 5A.

Examples of suitable diamines include, but are not limited to, N,N′-dimethyl-1,2-ethylenediamine, N,N′-diethylethylenediamine, N,N′-dimethyl-1,3-propanediamine, N,N′-dimethyl-1,4-butanediamine, N,N′-dimethyl-1,10-decanediamine, N,N′-diethyl-1,4-cyclohexanediamine, N,N′-dipropyl-1,4-cyclohexanediamine, 1,4-piperazine, N,N′-dimethyl-1,2-ethenediamine, N,N′-diethyl-1,3-benzenedimethanamine and N-cycloheptyl-N′-cyclohexyl-1,4-cyclohexanediamine. A number of these examples are illustrated by structural formulas in FIG. 5B.

Examples of suitable dicarboxylic acids include, but are not limited to, oxalic acid, malonic acid, succinic acid, glutaric acid, adipic acid, brassylic acid (1,13-tridecanedioic acid), 1,14-tetradecanedioic acid, 1,18-octadecanedioic acid, diglycolic acid, 1-methyl-3,5-piperidinedicarboxylic acid, decahydro-2,6-naphthalenedicarboxylic acid, and 5-(trimethylsilyl)-isophthalic acid. FIG. 5C shows structural formulas of some of these examples.

Examples of suitable dicarboxylic acid anhydrides include, but are not limited to, glutaric anhydride, 3-phenyl-glutaric anhydride, naphthalic anhydride, succinic anhydride, suberic anhydride (hexanedicarboxylic anhydride), sebacic anhydride (1,10-decanedioic acid anhydride), tridecanedioic anhydride, phthalic anhydride, 2,3-thiophenedicarboxylic anhydride, 4-isopropyl-4-methyldihydropyran-2,6-dione and cinchomeronic anhydride (3,4-pyridinedicarboxylic anhydride). Some of these examples are illustrated by structural formulas in FIG. 5D.

Examples of suitable dithiols include, but are not limited to, 1,2-dimercaptoethane, 1,3-dimercaptopropane, 1,4-butanedithiol, 1,10-decanedithiol, 1,13-tridecanedithiol, β,β′-dimercaptodiethyl ether, 1,4-benzenedimethanethiol, 1,3-benzenedimethanethiol, 3-methyl-1,5-pentanedithiol, 3,5-pyridinedimethanethiol and 2-(dimethoxymethylsilyl)-1,4-butanedithiol. FIG. 5F shows structural formulas of some of these examples.

Examples of suitable dialdehydes, which are preferably used after protecting the carbonyl groups in the form of a dithio acetal (cf. also para 69), include, but are not limited to, glutaraldehyde and 1,2-benzenedicarboxaldehyde. Examples of corresponding dithio acetals are 2,2′-(1,3-propanediyl)bis-1,3-dithiolane or glutaraldehyde bis(diphenylmercaptal) and 2,2′-(1,2-phenylene)bis-1,3-dithiane or 2,2′-(1,2-phenylene)bis-1,3-benzodithiole, respectively. Some of these examples are illustrated in FIG. 5E.

Examples of suitable diamides include, but are not limited to, N,N′-dimethyl-ethanediamide, N,N′-diisopropyl-succinamide, N,N′-diethyl-succinamide, N,N′-diethyl-malonamide, N,N′-diisopropyl-malonamide, N,N′-diethyl-succinamide, N,N′-diisopropyl-fumaramide, N,N′-diisopropyl-glutaramide, N,N′-dimethyl-glutaramide, N,N′-dimethyl-decanediamide, N,N′-dimethyl-dodecanediamide, N,N′-dimethyl-1,2-cyclohexanedicarboxamide, N,N′-diethyl-1,3-cyclohexanedicarboxamide, N,N′-dimethyl-1,3-cyclohexane-dicarboxamide, NN′-dimethyl-1,4-cyclohexanedicarboxamide, NN′-dimethyl-terephthalamide, N,N′-diethyl-terephthalamide, N,N′-dimethyl-1,3-benzenedicarboxamide, N,N′-dimethyl-1,2-benzenedicarboxamide and N,N′-dimethyl-3,5-pyridinedicarboxamide. Some of these examples are illustrated by structural formulas in FIG. 5G.

While the above examples are secondary diamides, primary diamides may also be suitable bifunctional nucleophilic compounds that may be used within the present invention. Preferably, primary diamides will be selected that undergo a reaction to a secondary diamide, but do not undergo a further reaction to a tertiary diamide. As the nitrogen atoms of a monosubstituted amide group have an increased nucleophilicity when compared to an unsubstituted amide group, a second reaction of the nitrogen atoms, i.e. the nucleophilic centers, will often occur. Unsubstituted diamides are thus not preferred bifunctional nucleophilic compounds for the use in the present invention.

Examples of suitable diimides include, but are not limited to, 2,2′-bisuccinimide, suberimide (octanimide), azacycloundecane-2,11-dione, azacyclotetradecane-2,14-dione, 1,2,3,4-cyclopentanetetracarboxylic-1,2:3,4-diimide, and 2-(3,6,7,8-tetrahydro-3,6,8-trioxo-2H-1-benzothiopyrano[6,5,4-def]isoquinolin-2-ylidene)2H-1-benzothiopyrano[6,5,4-def]isoquinoline-3,6,8(7H)-trione. Most of these examples are illustrated by structural formulas in FIG. 5H.

Examples of suitable dithianes include, but are not limited to, 2,2′-(1,3-propanediyl)bis-1,3-dithiolane, 2,2′-(1,6-hexanediyl)bis-1,3-dithiolane, 2,2′-(2,6-naphthalenediyl)bis-1,3-dithiolane, and 2,2′-(1,4-phenylene)bis-1,3-dithiolane. Some of these examples are illustrated by structural formulas in FIG. 51.

Examples of suitable diselenols include, but are not limited to, 1,2-ethanediselenol, 1,4-butanediselenol and 1,2-benzenedimethaneselenol. Most of these examples are illustrated by structural formulas in FIG. 5J.

Examples of suitable dimetallic compounds include, but are not limited to, ethylenebis[magnesium bromide], 1,3-dilithiopropane, 1,4-bis(trichlorostannyl)butane, [μ-[1,4-phenylenebis(methylene)]]di-sodium, μ-9,10-anthrylenedibromodi-mercury, and dichloro-μ-1,4-phenylenedi-zinc. These examples are illustrated by structural formulas in FIG. 5K.

Examples of suitable difunctional organo boronic acids include, but are not limited to, 5,6-decanediboronic acid, 1,2-ethanediyl-bis-boronic acid, 1,4-phenylenebis-boronic acid, 1,4-naphthalenediyl-bis-boronic acid, 2,5-thiophenediyl-bis-boronic acid and (boronocyclohexylidenemethyl)-boronic acid. A number of these examples are illustrated by structural formulas in FIG. 5L.

Alternatively, compounds with two different nucleophiles may be used. Examples of compounds with two different nucleophiles are for instance hydroxyacids. Examples of suitable hydroxyacids include, but are not limited to, 3-(2-hydroxyethoxy)-propanoic acid, β-hydroxy-α-(trimethylsilyl)-benzenepropanoic acid, 4-(hydroxymethyl)-benzoic acid, 4-hydroxy-2,6-bis(hydroxymethyl)-benzoic acid, 4-(hydroxymethyl)-3-pyridinecarboxylic acid, and tetrahydro-4-hydroxy-2H-thiopyran-3-carboxylic acid. Most of these examples are illustrated by structural formulas in FIG. 5M.

Other suitable nucleophilic compounds are for instance N-ethyl(mercapto-ethyl)amine, 3,5-piperidinedicarboxylic acid, 4-(mercaptomethyl)-benzoic acid and 4-(methylamino)-1-butanol. These examples are illustrated by structural formulas in FIG. 5N.

If more than one nucleophilic compound is used in the reaction with the α-functional unsaturated monomer(s), any suitable combination in any ratio may be chosen. The selection may for instance be made with an intention to avoid the occurrence of side reactions between the two or more nucleophilic compounds. Although any combination of two or more nucleophilic compounds may be used, regardless of potential relative reactivity differences with respect to each other, it should be observed that nucleophilicity differences may affect the composition of the polymer product as explained below (cf. e.g. para 94 et sqq.).

As already mentioned, the nucleophilic compound(s) used in the present invention may optionally include additional functional groups, as long as these are not able to participate in the polymerisation under the respective reaction conditions selected. Likewise, the α-functional unsaturated monomer(s) may optionally contain additional functional groups besides the two leaving groups L¹ and L², as long as these are not able to participate in the polymerisation under the respective reaction conditions. The phrase “reacting solely” as used herein thus refers to the fact that additional educts, such as for instance capping agents or cross-linking agents—if present at all—do not take part in the reaction of the present invention in order to obtain the linear polyunsaturated polymer products. Where it is desired to use reactants containing additional functional groups, it should however be observed that not all functional groups are compatible with all polymerisation reactions of the present invention, even if they are not able to participate in the polymerisation process. Certain nucleophilic groups like amino groups may for instance be catalyst poisons in cross coupling reactions. The skilled person may therefore take a selection of monomers with an intention to avoid undesired reactions, for instance by selecting compounds without such respective additional functional groups, or by shielding them (cf below).

Where monomers contain additional functional groups, which have a much lower reactivity under the respective reaction conditions than two functional groups serving as nucleophilic or as leaving groups, such functional groups will generally not participate in the polymerisation reaction. Fluorine as one example reacts sluggishly when compared to leaving groups such as azido- or iodo-groups. It does therefore not participate in the polymerisation reaction, as long as azido- or iodo-groups are present in the same molecule. As an other example, halogen or CHO-substituents in an ortho- or para position to a hydroxyl group on an aromatic ring generally possess a much lower reactivity than the respective hydroxyl group.

Compounds comprising additional functional groups with a reactivity comparable to Nu¹ and Nu² or L¹ and L² may however not be suitable as monomers for the present invention as such. Such monomers may result in highly cross-linked unsaturated polymers, in particular if all functional groups within the monomer are identical. Persons skilled in the art will be aware of the fact that highly cross-linked polymers tend to be brittle in nature. Furthermore, the potential of highly cross-linked polymers to undergo subsequent modification reactions as indicated below (cf. paras 121 et sqq) is limited, as they are neither soluble nor of favourable heat processability characteristics.

Nevertheless, if compounds comprising additional functional groups are desired to be used in the present invention, this can be achieved by the use of protective groups, which is a well established method in the art. Using this approach, functional groups exceeding the number of two are shielded from participating in the polymerisation process. If it is for instance desired to employ a tetracarboxylic dianhydride as a nucleophilic compound, two of the acid groups in such a molecule may be shielded and the remaining carboxylic acid groups may be reacted. A large number of protective groups, which are well known to those skilled in the art, is available for various functional groups. As an example, carboxylic groups as nucleophiles may be protected by converting them into an ester, while hydroxyl groups may for instance be protected by an isopropylidene group. Such protective groups may be removed after polymerisation and thus provide additional options for modifications of the obtained linear polymer. For example, the isopropylidene protective group shielding a hydroxyl group may be removed by acid treatment. Those skilled in the art will furthermore be aware that such protective groups may have to be introduced well in advance during the synthesis of the respective monomer.

While the polymerisation reaction of the present invention results in unbranched polymer chains, a certain amount of cross-linking may subsequently be introduced into the backbone of the linear polymers of the present invention. For this purpose, monomers with more than two functional groups may be added to the obtained polymer. For this purpose, any suitable oligofunctional compound with independently selected functional groups may be used, as long as it does not prevent a polymerisation reaction to occur. As two examples, oligofunctional α-functional unsaturated monomers or oligofunctional nucleophilic compounds may be chosen.

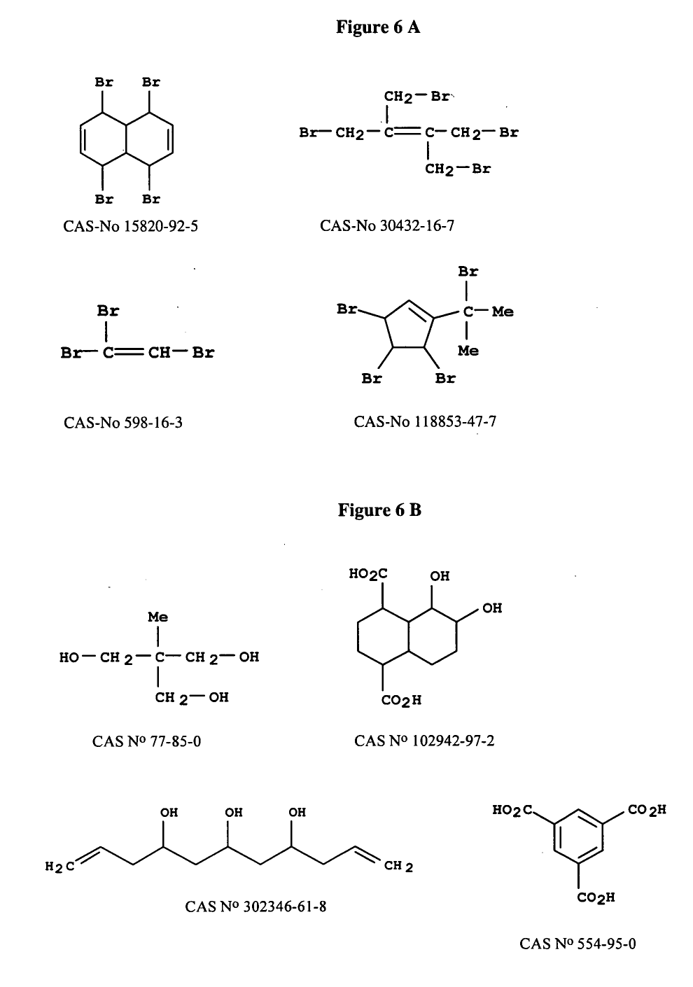

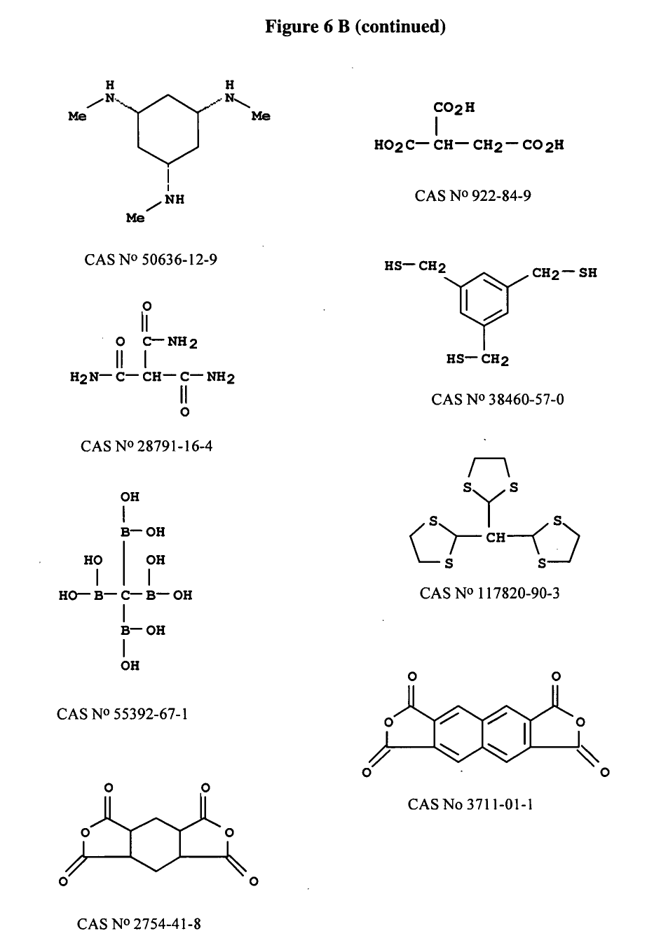

Oligofunctional α-functional unsaturated monomers comprising three or four leaving groups may for instance be molecules, in which any of R¹ to R⁹ or A, B or C (cf. structural formulas in para. 38 et sqq.) contain additional leaving groups. Examples of such suitable oligofunctional α-functional unsaturated monomers may include, but are not limited to, 1,4,5,8-tetrabromo-1,4,4a,5,8,8a-hexahydro-naphthalene, tetra(bromomethyl) ethane, tribromoethylene, and 3,4,5-tribromo-1-(1-bromo-1-methylethyl)-cyclopentene. These examples are illustrated by structural formulas in FIG. 6A.

Nucleophilic compounds comprising three, four etc. nucleophiles may for instance also be molecules in which any of R¹¹, R¹³ and R¹⁵ or D or E (cf. structural formulas in para. 58) contain additional nucleophiles. Examples of such suitable nucleophilic compounds may include, but are not limited to, 1,3,5-cyclohexanetriol, N,N′,N″-trimethyl-1,3,5-cyclohexanetriamine, 1,3,5-cyclohexanetricarboxylic acid, 1,10-undecadiene-4,6,8-triol, 1,1,1-tris(n-methylaminomethyl)ethane, methanetricarboxylic acid, methanetricarboxamide, N,N′-bis(hydroxymethyl)-3,5-pyridinedicarboxamide, N,N′-bis(5-benzamido-1-anthraquinonyl)-5-(trimethylsilyl)-isophthalamide, 1,3,5-benzenetricarboxylic acid, benzenetricarboxamide, 1,3,5-benzenetrimethanethiol, 1,1,1-tris(mercaptomethyl)-ethane, 1,3,5-cyclohexanetrimethanethiol, 1,3,5-cyclohexanetrithiol, 2,2′,2″-methylidynetris-1,3-dithiolane, decahydro-5,6-dihydroxy-1,4-naphthalenedicarboxylic acid, methanetetrayltetrakis boronic acid, 1,2,4,5-cyclohexanetetracarboxylic dianhydride, 3a,4,8,8a-tetrahydro-1H,3H-benzo[1,2-c:4,5-c′]difuran-1,3,5,7-tetrone, and 2,3,6,7-naphthalenetetracarboxylic dianhydride. Some of these examples are illustrated by structural formulas in FIG. 6B.

The process for preparing a linear polyunsaturated polymer includes a nucleophilic displacement reaction between one or more α-functional unsaturated monomers and one or more nucleophilic compounds. The reaction at each leaving group of an α-functional unsaturated monomer can be summarized by equation I: 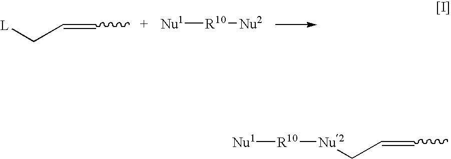
wherein Nu′² is a group originating from functional group Nu², which comprised a nucleophile. As the other leaving group of the respective α-functional unsaturated monomer as well as the other nucleophile of the respective nucleophilic compound undergo similar reactions, polymerisation occurs.

Hence, the overall polymerisation reaction for typical embodiments of compounds of structure II may be illustrated by equation II:
L¹-CR¹R²—CR³═CR⁴—CR⁵R⁶-L²+Nu¹-R¹⁰-Nu²→—[CR¹R²—CR³═CR⁴—CR⁵R⁶-Nu′¹-R¹⁰-Nu′²]- [II]
wherein Nu′¹ and Nu′² are groups originating from the respective functional groups comprising the nucleophiles. A change occurs within these functional groups due to the nature of the reaction being a displacement. During this displacement the incoming nucleophile changes its ligand state within the original functional group. Examples of such changes are the loss of a proton in cases where Nu¹ and Nu² are amino-, amido-, alcohol-, carboxyl-, imido- or thio groups.

Likewise, the overall polymerisation reaction for typical embodiments of compounds of structure III may be illustrated by equation III: 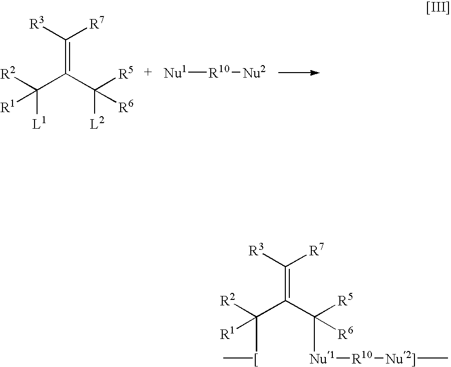
wherein Nu′¹ and Nu′² are groups originating from the respective functional groups comprising the nucleophiles.

The polymerisation reaction for typical embodiments of compounds of structure IV may be illustrated by equation IV:
L¹-CR¹R²—CR³═CR⁴-A-CR⁸═CR⁹—CR⁵R⁶-L²+Nu¹-R¹⁰-Nu²→—[CR¹R²—CR³═CR⁴-A-CR⁸═CR⁹—CR⁵R⁶-Nu′¹-R¹⁰-Nu′²]- [IV]
wherein Nu′¹ and Nu′² are groups originating from the respective functional groups comprising the nucleophiles.

The polymerisation reaction for typical embodiments of compounds of structure V may be illustrated by equation V: 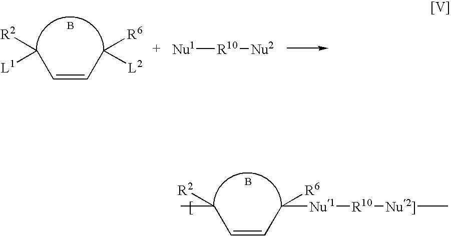
wherein Nu′¹ and Nu′² are groups originating from the respective functional groups comprising the nucleophiles.

The polymerisation reaction for typical embodiments of compounds of structure VI may be illustrated by equation VI: 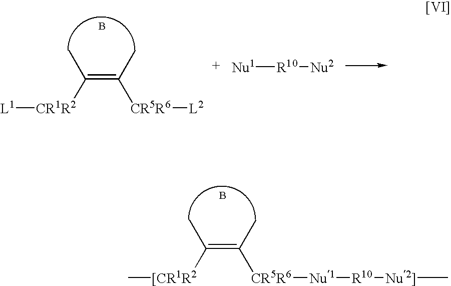
wherein Nu′¹ and Nu′² are groups originating from the respective functional groups comprising the nucleophiles.

The polymerisation reaction for typical embodiments of compounds of structure VII may be illustrated by equation VII: 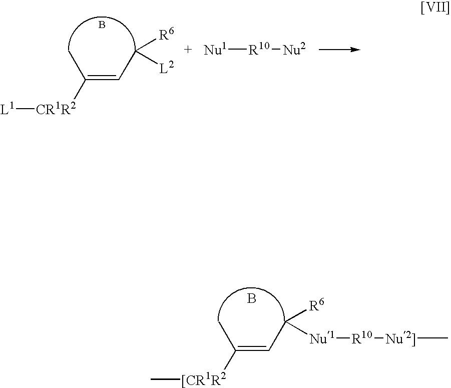
wherein Nu′¹ and Nu′² are groups originating from the respective functional groups comprising the nucleophiles.

The polymerisation reaction for typical embodiments of compounds of structure VIII may be illustrated by equation VIII: 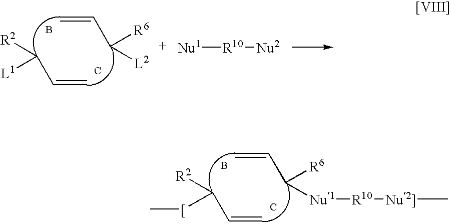
wherein Nu′¹ and Nu′² are groups originating from the respective functional groups comprising the nucleophiles.

The polymerisation reaction for typical embodiments of compounds of structure IX may be illustrated by equation IX:

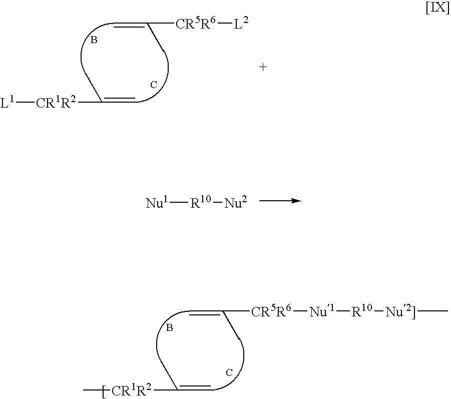

wherein Nu′¹ and Nu′² are groups originating from the respective functional groups comprising the nucleophiles.

The polymerisation reaction for typical embodiments of compounds of structure X may be illustrated by equation X: 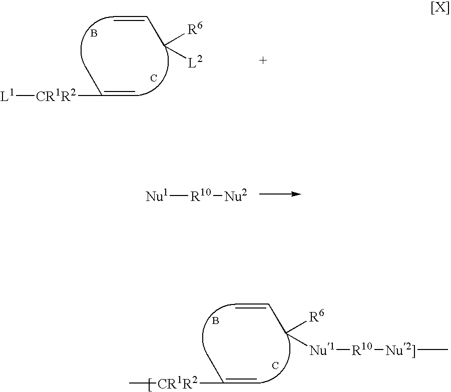
wherein Nu′¹ and Nu′² are groups originating from the respective functional groups comprising the nucleophiles.

As can be seen from the illustrating examples above, the linear modifiable unsaturated polymers may comprise aromatic moieties or conjugated unsaturated systems. Both aromatic moieties and conjugated systems may be introduced into the side chains of the polymer by a respective selection of any of R¹ to R¹⁵ or A to D in one or more of the monomers (cf. structural formulas in para 38 et sqq and para 57 et sqq). Furthermore, aromatic monomer units may be incorporated into the linear polymer backbone by means of a selection of respective bifunctional nucleophilic compounds (e.g. R¹⁰ in para 57). As the one or more α-functional unsaturated monomer is a non-aromatic structure, the linear modifiable unsaturated polymers of the present invention do however in no case contain solely aromatic monomer units. As the leaving groups of the α-functional unsaturated monomer(s) are separated from a non aromatic carbon-carbon double bond by one carbon atom (cf. above), the polymer backbone neither consists of a conjugated system. Thus, the preserved carbon-carbon double bonds, which originate from the α-functional unsaturated monomer(s), are isolated from such systems and consequently reactive, so that they easily undergo subsequent modification reactions.

If more than one nucleophilic compound is used in the reaction with the α-functional unsaturated monomer(s), it should be observed that nucleophilicity differences between the nucleophiles of the two or more nucleophilic compounds will effect the course of the reaction with the α-functional unsaturated monomer(s). Consequently the structure and properties of the polymeric product will be affected. In a mixture of, for instance, a dithiol and a dicarboxylic acid, in most cases the thiol groups of the dithiol will posess a higher nucleophilicity. While the use of nucleophilic compounds with a comparable nucleophilicity of their functional groups will generally result in a random distribution of monomer units in the reaction product, differences in nucleophilicity will typically result in the more nucleophilic compounds prevailing during the initial phase of polymerization. In the latter case the less nucleophilic compounds will generally react during the later phases of the reaction.

In the above example of a mixture of a dithiol and a dicarboxylic acid, the polymerisation will hence largely progress in two stages. Initially, the dithiol as the compound with functional groups of the higher nucleophilicity will dominate the reaction as shown in exemplary equation XI below: 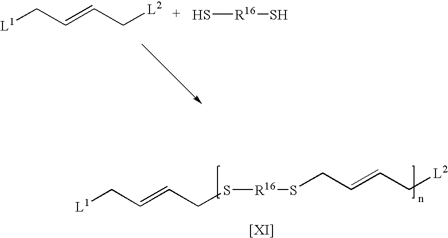
wherein n is a growing integer representing the increasing chain length of the linear polymer chain, and R¹⁶ may for instance be an aliphatic or cycloaliphatic alkyl group. As the amount of the dithiol left in the reaction mixture decreases, the dicarboxylic acid comprising the second nucleophile will increasingly participate in the reaction as shown in exemplary equation XII below: 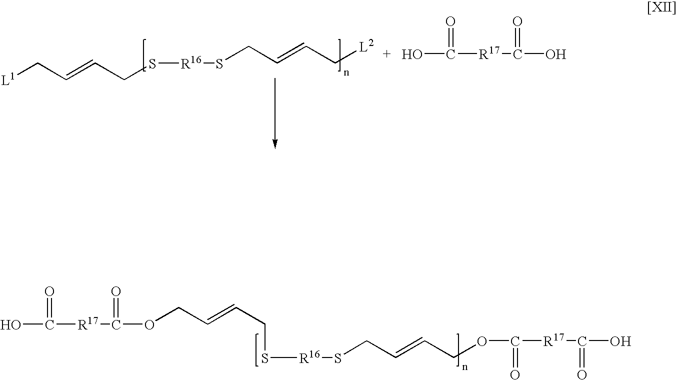
Due to the lack of dithiol left in the reaction mixture, the polymerisation will now largely continue in form of a second phase, which is a continuation of the reaction illustrated in equation XII.

Typical examples for the use of two nucleophilic compounds with a comparable nucleophilicity of their functional groups are the use of two difunctional nucleophilic compounds with the same functional groups such as two different diamines. In such a case both diamines will, throughout the entire polymerisation process, compete in the reaction with the α-functional unsaturated monomer. Therefore two reactions such as shown in exemplary equations XIII and XIV below will randomly take place at the same oligomer backbone from the beginning of the polymerisation: 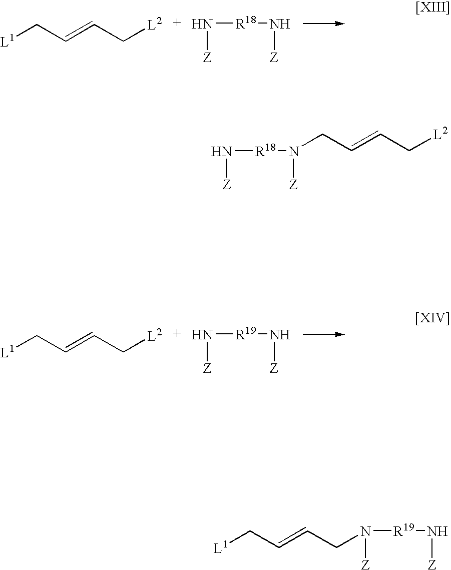
wherein R¹⁸, R¹⁹ and Z may, independently of one another, be an aliphatic or cycloaliphatic alkyl group, an aromatic or arylaliphatic group or H. The amino groups and leaving groups of the growing oligomer will generally continue randomly with reactions as depicted in equations XIII and XIV, so that a random distribution of monomer units in the reaction product will generally result.

Where it is desired to use compounds with more than two functional groups as monomers, a shielding of such additional groups by protective groups may be required. As explained above (cf. e.g. para 79), such protection is required long as these additional functional groups are of a reactivity that will otherwise allow them to take part in the polymerisation reaction. In equation XV the use of a nucleophilic compound comprising a shielded additional functional group Nu³ as a monomer is illustrated. The group Nu³ has been shielded by a protective group X. The two unprotected functional groups of the respective nucleophilic compound react with the α-functional unsaturated monomer in a similar manner as illustrated above: 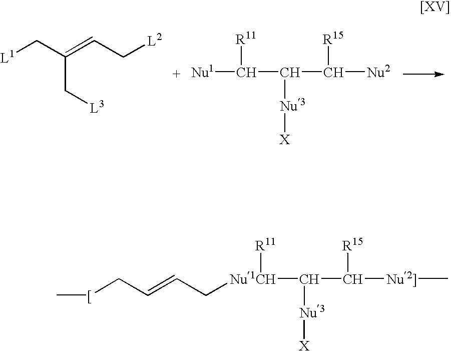
wherein Nu′¹, Nu′² and Nu′³ are groups originating from the respective functional groups comprising the nucleophiles, and X is a protective group.

Where it is desired to use bifunctional compounds that contain functional groups, which can undergo more than one reaction under the chosen reaction conditions, a similar approach may be taken. Such functional groups may be shielded by protective groups, so that the respective nucleophilic centers can undergo only one reaction under the chosen reaction conditions. If the bifunctional compound(s) for instance contain amide groups, examples of suitable protective groups include, but are not limited to, carbobenzoxy-(Cbz) and t-butoxycarbonyl-(t-BOC) groups. Carbobenzoxy groups may subsequently be removed by hydrogenation in presence of a palladium catalyst or by treatment with HBr in acetic acid. T-butoxycarbonyl groups may be removed by treatment with trifluoro acetic acid. The selection of respective protective groups may thus be taken in view of any subsequently desired modification (cf. para 121 et sqq.).

Without the use of protective groups, additional functional groups present in the bifunctional nucleophilic compound(s) may react in an analogous way as Nu¹ and Nu² in equation XV. As a consequence the polymerisation reaction would result in a highly branched and crosslinked product instead of a linear polymer. However, once a linear polymer containing an unbranched backbone has been obtained through the polymerisation reaction of the present invention, it may in some embodiments be desired to subsequently introduce a certain amount of branches into the polymer backbone. In such cases a small amount of compounds with more than two functional groups may be added to the linear polymer. Nucleophilic compounds with more than two functional groups react with the growing polymer chain as illustrated in equation XVI: 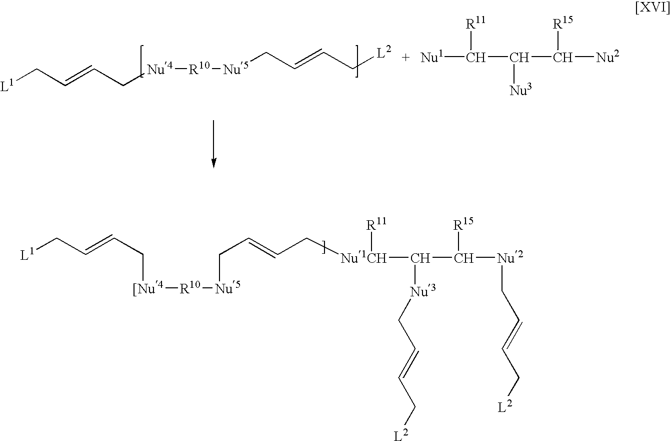
wherein Nu′⁴ and Nu′⁵ are groups originating from functional groups Nu⁴ and Nu⁵, and Nu′¹, Nu′² and Nu′³ are groups originating from the shown functional groups Nu¹, Nu² and Nu³, comprising the respective nucleophiles. In the example shown in equation XVI the polymer chain may continue to grow in three directions. If this modification reaction is performed within the obtained reaction mixture, at a final stage of the polymerisation reaction, a nucleophilic compound with for example three functional groups will mainly connect existing linear chains.

Alternatively, such a modification reaction may include the usage of α-functional unsaturated monomers with more than two leaving groups for crosslinking purposes, as shown in equation XVII: 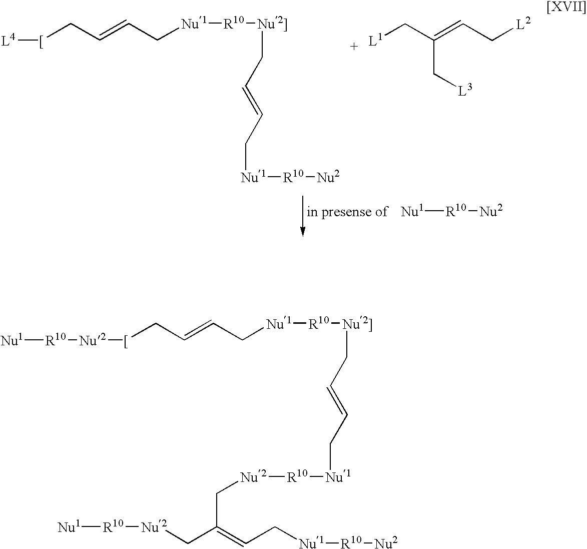
wherein Nu′¹ and Nu′² are groups originating from the respective functional groups comprising the nucleophiles. Again, if performed within the obtained reaction mixture, at a late stage of the reaction, an α-functional unsaturated monomer with for example three functional groups will mainly connect existing chains.

Any suitable solvent may be used, whether nonpolar aprotic, nonpolar protic, dipolar protic or dipolar aprotic. It should be understood that suitable solvents will allow for a polymerisation reaction to take place. Examples of nonpolar aprotic solvents include, but are not limited to, hexane, heptane, cyclohexane, benzene, toluene, p-xylene, pyridine, dichloromethane, chloroform, carbon tetrachloride, carbon disulfide, tetrahydrofuran, dioxane, diethyl ether, diisopropylether, ethylene glycol monobutyl ether or tetrahydrofuran. Examples of dipolar aprotic solvents are methyl ethyl ketone, methyl isobutyl ketone, acetone, cyclohexanone, ethyl acetate, isobutyl isobutyrate, ethylene glycol diacetate, dimethylformamide, acetonitrile, N,N-dimethyl acetamide, nitromethane, acetonitrile, N-formylpiperidine, N-methylpyrrolidone, and dimethylsulfoxide. Examples of polar protic solvents are methanol, ethanol, butyl alcohol, formic acid, dimethylarsinic acid [(CH₃)₂AsO(OH)], N,N-dimethyl-formamide, N,N-diisopropylethylamine, or chlorophenol. Examples of nonpolar protic solvents are acetic acid, tert.-butyl alcohol, phenol, cyclohexanol, or aniline.

Suitable solvents that may be used for the present invention include solvents that are nonreactive under the selected reaction conditions as well as solvents that are reactive under the selected reaction conditions. Nevertheless, the pure fact that certain solvents may themselves be able to react as nucleophilic compounds, may be taken into consideration for the selection of the solvent. In some embodiments such side reactions may be desired for capping or for introducing additional numbers of monomers in various amounts. In other embodiments such side reactions may however be undesired. In these cases solvents may be selected that do not contain nucleophiles which may react in nucleophilic displacement reactions. Alternatively, in these cases it may be sufficient to choose solvents with nucleophiles of a lower nucleophilicity than the nucleophilic compounds selected as monomers for the polymerisation with the α-functional unsaturated monomer.

The person skilled in the art may furthermore be aware of the fact that an allylic rearrangement is a potential side reaction for a nucleophilic substitution of an α-functional unsaturated compound. Although such side reactions usually do not occur during the processes of the present invention, their potential occurrence may be taken into consideration for the selection of the solvent. Hence, if the product spread resulting from an allylic rearrangement is undesirable, a polar solvent will generally be chosen. Furthermore, it may be advisable to take other well-known solvent effects into consideration in the selection of the solvent. One example is the rule that the freer the nucleophile, the greater the rate of its reaction. Another example is the rule that the reaction rate will change with solvent polarity, and that this change depends on the charge in the transition state of the reaction compared to the starting material. Accordingly, in a number of cases either a dipolar aprotic solvent or a nonpolar aprotic solvent will be selected.

The preparation of polyunsaturated polymers from α-functional unsaturated compounds and nucleophilic compounds comprising two nucleophiles can take place at any suitable temperature, and in this respect accordingly also under mild conditions. The temperature for the reaction may therefore be selected within any range that does not lead to a decomposition of the reactants. In some embodiments it may be chosen within the range of about −20° to about 110° C., in another embodiment within the range of about 0° to about 70° C. and yet in a further embodiment at room temperature, i.e. about 20 to about 25° C.

In one embodiment of the invention catalytic amounts of an acid or a base are added in order to activate the nucleophiles. Any suitable Brønstedt acid, Brønstedt base, Lewis acid or Lewis base may be used. Some selections may for instance comprise the use of a Brønstedt base. Such a base will take the role of removing acidic protons of the α-functional unsaturated compound(s). Examples of such bases include, but are not limited to, inorganic bases or organometallic bases. Examples of inorganic bases include, but are not limited to, calcium hydroxide, potassium hydroxide, sodium hydroxide, or potassium carbonate. Examples of organometallic bases include, but are not limited to, potassium t-butoxide, n-butyl lithium sec-butyl lithium or phenyldimethylsilyllithium.

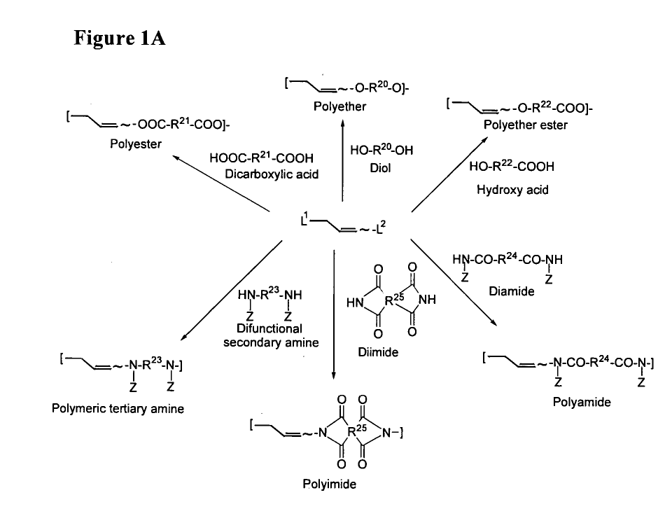

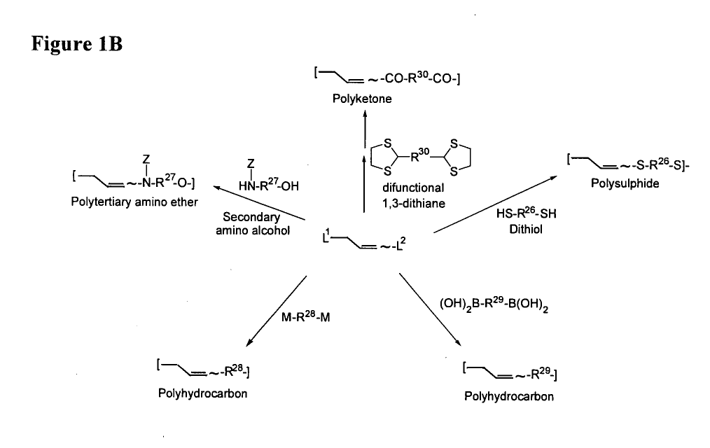

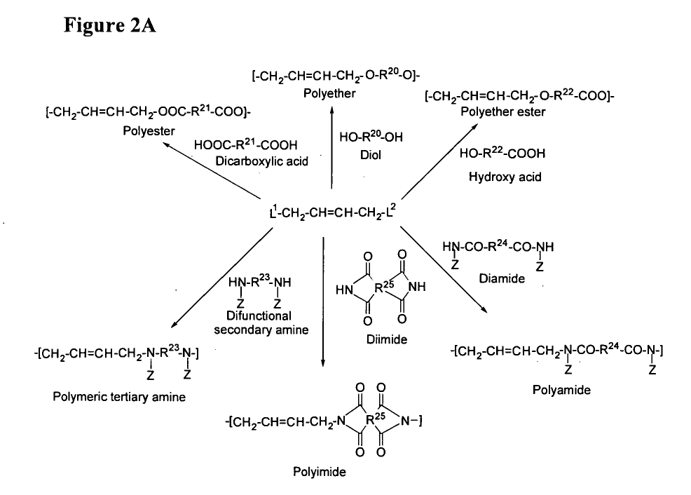

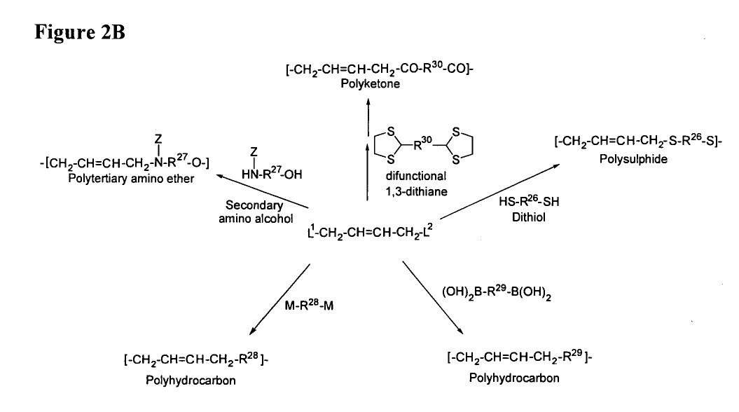

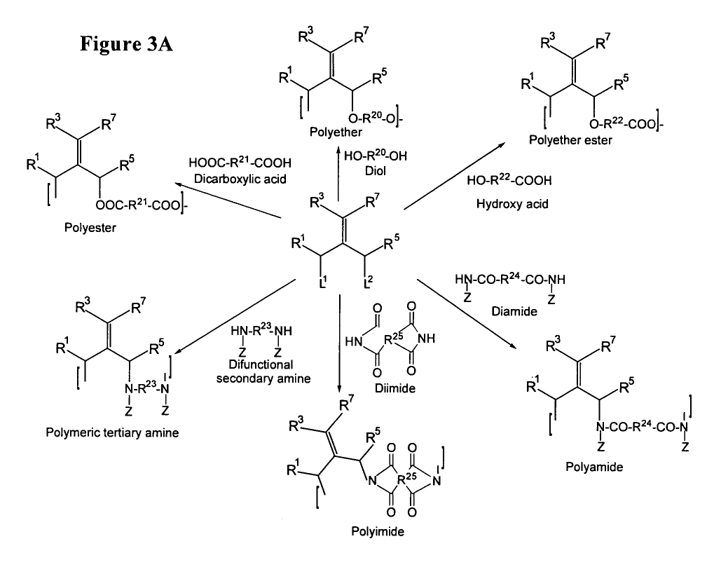

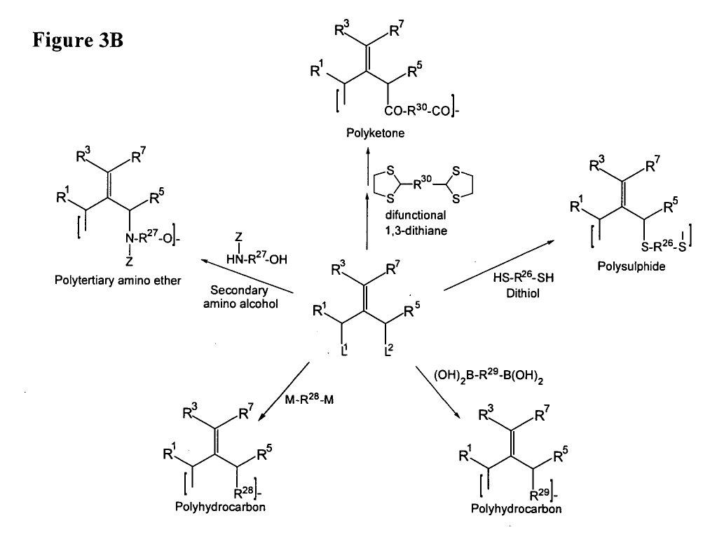

Depending on the monomers selected, the method of the present invention may result in many types of polyunsaturated polymers including novel co-polymers. Examples include, but are not limited to, polyunsaturated polyethers, polyunsaturated polyesters, polyunsaturated polyether esters, polyunsaturated polytertiary amines, polyunsaturated polyamides, polyunsaturated polyimides, polyunsaturated polysulphides, polyunsaturated poly tertiary amino ethers, polyunsaturated poly ketones or polyunsaturated hydrocarbons. In the following, 11 exemplary methods of synthesis of these polymers shall be summarised. An exemplary overview of respective polymerisation reactions is also depicted in FIGS. 1 to 3.

1. Polyunsaturated polyethers: Various diols may be used as nucleophiles for displacing leaving groups from one or more α-functional unsaturated compound(s), in which case the linear polymers produced are polyunsaturated polyethers. Examples of reactions of embodiments of α-functional unsaturated compounds of structure II and structure III include, but are not limited to, the reactions depicted in equations XVIII and IXX below: 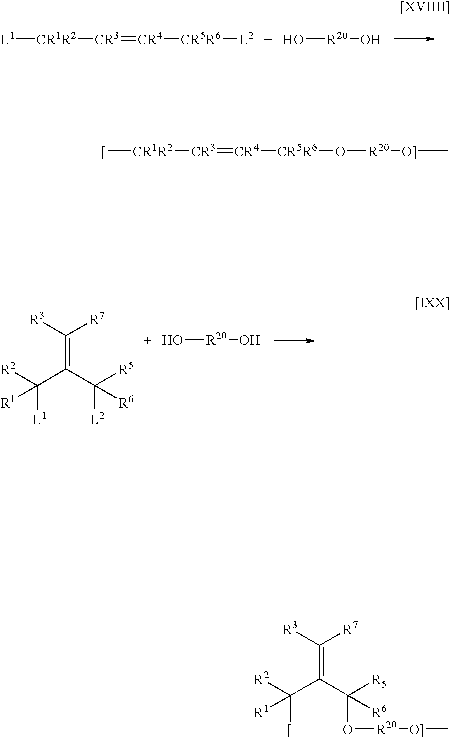
where R²⁰ can be alkyl, cycloalkyl, aryl, or aralkyl. In some embodiments the group R²⁰ may for instance possess a main chain of a length of 2 to about 20 carbon atoms, while in other embodiments one or more polymeric diols may be used. The group R²⁰ may also contain other polar, non-polar, saturated or unsaturated groups so long as these groups do not take part in and do not prevent the polymerization reaction. Optionally the group R²⁰ may be chosen with the intent to little interference or no interference with the polymerisation reaction. α-functional unsaturated compounds of other suitable structures, such as structures IV to VIII, will react in an analogous way, as illustrated in equations IV to VIII.

Examples of suitable diols which are useful for the preparation of unsaturated polyethers according to the present invention include, but are not limited to, ethylene glycol, propane diol, 2-methyl propane diol, butane diol, isomeric cyclohexane dimethanols, isomeric cyclohexane diols, isomeric dihydroxy benzenes, isomeric biphenols, Bisphenol-A, isomeric benzophenone diols, isomeric diphenyl sulfone diols, sulfonic acid substituted dihydroxy benzenes, and hydroxyl terminated polydimethyl siloxanes. Hydroxyl terminated polydimethyl or diphenyl or phenyl methyl siloxanes will generally be selected in the molecular weight range of 100 to 100,000, in other embodiments in the molecular weight range of 1000 to 10,000 and in yet another embodiment in the molecular weight range of 200 to 1000. Another example of suitable diols are polyether polyols. These include, but are not limited to, for instance polyethylene glycol, polypropylene glycol or polytetramethylene glycol. While all such hydroxyl terminated oligomers may be used as nucleophiles, the skilled person may take an initial selection with a view to the amount of unsaturated bonds in the reaction product and to the amount of available reactive groups. As an example, where 1,4-dihalo-2-butene is reacted with hydroxyl terminated poly dimethyl siloxane of a molecular weight of for instance 10,000, assuming a degree of polymerization of for instance 50, the resulting polymer chain will carry an unsaturated bond for about about every 50 units. As an alternative example, where the same reaction is performed with hydroxyl terminated poly dimethyl siloxanes of a molecular weight of for instance 1000, assuming a degree of polymerization of for instance 5, the unsaturated bond will be alternated on about every 6th unit. In some embodiments hydroxyl terminated oligomers will thus be selected in the lower molecular weight range as for instance below 1000.

2. Polyunsaturated polyesters: Different kinds of dicarboxylic acids can be used as nucleophiles for displacing leaving groups from one or more α-functional unsaturated compound(s) in which case the linear polymers produced are polyunsaturated polyesters. Examples of reactions of embodiments of α-functional unsaturated compounds of structure II and structure V include, but are not limited to, the reactions depicted in equations XX and XXI below: 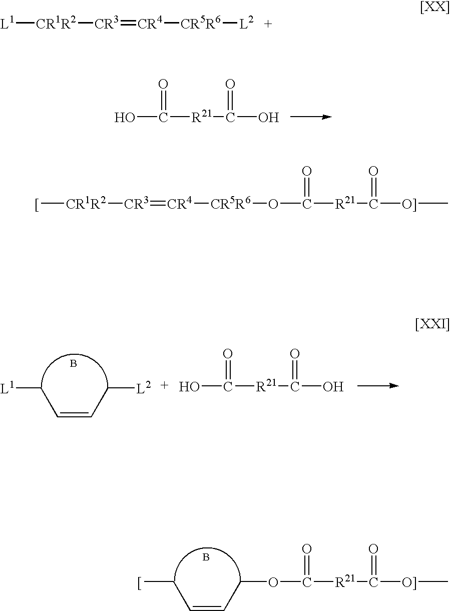
where R²¹ can be alkyl, cycloalkyl, aryl, or aralkyl. In some embodiments the group R²¹ may for instance possess a main chain of a length of 2 to about 20 carbon atoms, while in other embodiments one or more polymeric dicarboxylic acids may be used. The group R²′ may also contain other polar, non-polar, saturated or unsaturated groups so long as these groups do not take part in and do not prevent the polymerisation reaction from taking place. Optionally the group R²¹ may be chosen with the intent that it will only slightly or not at all retard the polymerisation reaction. Dicarboxylic acid anhydrides may furthermore be used instead of dicarboxylic acids. α-functional unsaturated compounds of other suitable structures, such as structures III, IV or VI to X, will react in an analogous way, as illustrated in equations III, IV and VI to X. Some of the common dicarboxylic acids are: oxalic acid, malonic acid, succinic acid, glutaric acid, adipic acid, pimelic acid, suberic acid, azelaic acid, sebacic acid, phthalic acid, isophthalic acid, terephthalic acid, isomeric oxydibenzoic acids, isomeric cyclohexane dicarboxylic acids etc.

3. Polyunsaturated polyether esters: Many types of hydroxyacids may be used as nucleophiles for displacing leaving groups from one or more α-functional unsaturated compound(s), in which case the linear polymers produced are polyunsaturated polyether esters. Examples of reactions of embodiments of α-functional unsaturated compounds of structure II and structure IX include, but are not limited to, the reaction shown in equations XXII and XXIII below: 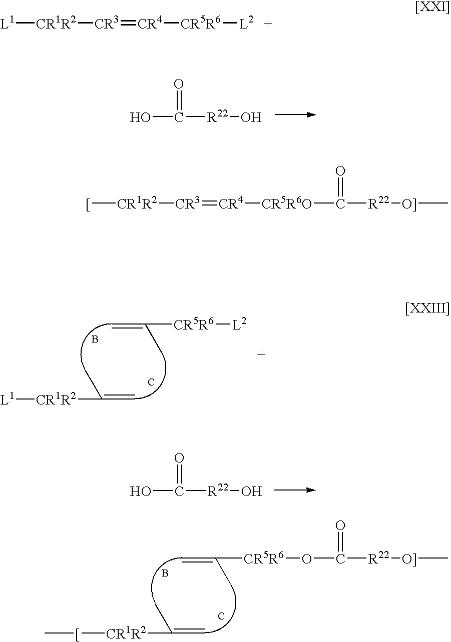
where R²² can be alkyl, cycloalkyl, aryl, or aralkyl. In some embodiments the group R²² may for instance possess a main chain of a length of 2 to about 20 carbon atoms, while in other embodiments one or more polymeric hydroxyacids may be used. Furthermore, the group R²² may also contain other polar, non-polar, saturated or unsaturated groups so long as these groups do not take part in and do not prevent the polymerization reaction. Optionally the group R²² may be chosen with the intent that it will only slightly or not at all retard the polymerisation reaction. α-functional unsaturated compounds of other suitable structures, such as structures III to VIII and structure X, will react in an analogous way, as illustrated in equations III to VIII and X. Some of the commonly used hydroxyacids are different isomers of lactic acid, isomeric hydroxybenzoic acids, etc. A useful hydroxyacid may be the various forms of tartaric acid. By protecting the two carboxylic acids of tartaric acid polyunsaturated polyethers can be prepared. Similarly, by protecting the two hydroxyl groups of tartaric acid polyunsaturated polyesters can be prepared. In both cases the respective groups can be deprotected to give the functional polyunsaturated polyethers and polyesters.

4. Polyunsaturated polytertiary amines: One type of nitrogen which can be used as nucleophile for displacing leaving groups from one or more α-functional unsaturated compound(s) is a difunctional secondary amine, in which case the linear polymers produced are polyunsaturated polytertiary amines. Examples of reactions of embodiments of α-functional unsaturated compounds of structure II and structure III include, but are not limited to, reactions as shown in equations XXIV and XXV below: 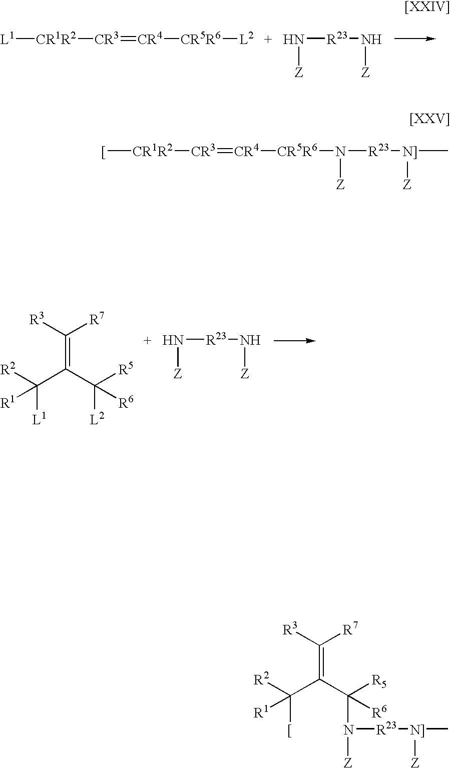
where R²³ can be alkyl, cycloalkyl, aryl, or aralkyl. In some embodiments the group R²³ may for instance possess a main chain of a length of 2 to about 20 carbon atoms, while in other embodiments one or more polymeric difunctional secondary amines may be used. The group R²³ may also contain other polar, non-polar, saturated or unsaturated groups so long as these groups do not take part in and do not prevent the polymerization reaction. Optionally the group R²³ may be chosen with the intent that it will only slightly or not at all retard the polymerisation reaction. Z may be methyl, phenyl, cyclohexyl, cyclohexyl methyl, phenyl methyl etc. One such common secondary amine is piperazine. α-functional unsaturated compounds of other suitable structures, such as structures IV to X, will react in an analogous way, as illustrated in equations IV to X.

5. Polyunsaturated polyamides: Another type of nitrogen which can be used as nucleophile for displacing leaving groups from one or more α-functional unsaturated compound(s) is a difunctional secondary amide, in which case the linear polymers produced are polyunsaturated polyamides. Example of reactions of embodiments of an α-functional unsaturated compound of structure II include, but are not limited to, the reaction shown in equation XXVI below: 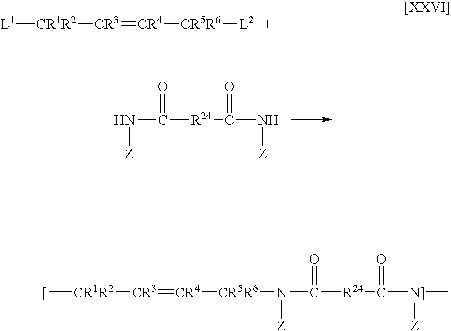
where R²⁴ can be alkyl, cycloalkyl, aryl, or aralkyl. In some embodiments the group R²⁴ may for instance possess a main chain of a length of 2 to about 20 carbon atoms, while in other embodiments one or more polymeric secondary diamides may be used. The group R²⁴ may also contain other polar, non-polar, saturated or unsaturated groups so long as these groups do not take part in and do not prevent the polymerization reaction. Optionally the group R²⁴ may be chosen with the intent that it will only slightly or not at all retard the polymerisation reaction. Z may be methyl, phenyl, cyclohexyl, cyclohexyl methyl, phenyl methyl etc. As explained above, in some embodiments Z may also be H, as long as the substituted amide obtained in the polymerisation reaction is not able to undergo a second reaction (cf. e.g. para 67). These amide reactants can be the derivatives of dicarboxylic acids mentioned in equations XX and XXI. α-functional unsaturated compounds of other suitable structures, such as structures III to X, will react in an analogous way, as illustrated in equations III to X.

6. Polyunsaturated polyimides: Yet another type of nitrogen which can be used as nucleophile for displacing leaving groups from one or more α-functional unsaturated compound(s) is a difunctional cyclic secondary amide, in which case the linear polymers produced are polyunsaturated polyimides. Examples of reactions of an embodiment of a α-functional unsaturated compound of structure II include, but are not limited to, the reaction depicted in equation XXVII below: 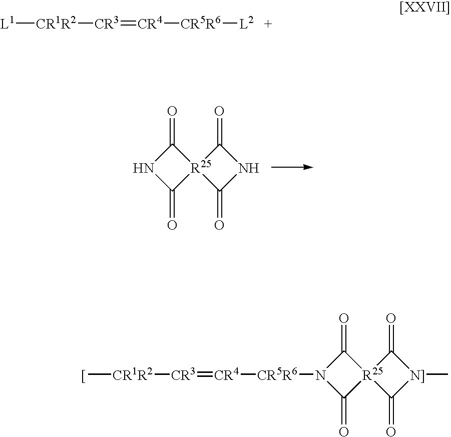
where R²⁵ can be alkyl, cyclic, cycloalkyl, aryl, or aralkyl. In some embodiments the group R²⁵ may for instance possess a main chain of a length of 2 to about 20 carbon atoms, while in other embodiments one or more polymeric cyclic secondary amides may be used. The group R²⁵ may also contain other polar, non-polar, saturated or unsaturated groups so long as these groups do not take part in and do not prevent the polymerization reaction. Optionally the group R²⁵ may be chosen with the intent that it will only slightly or not at all retard the polymerisation reaction. These imides are reaction products of ammonia or its derivatives with various diphthalic anhydrides which are commonly employed in the preparation of polyimides. Some of the dianhydrides which are suitable are: pyromellitic anhydride, benzophenone tetracarboxylic dianhydride, various isomers of oxydiphthalic anhydride, thiodiphthalic anhydride, diphthalic anhydrides containing many other linking groups like —CH₂—, —C(CH₃)₂—, C(CF₃)₂—, —SO₂—, etc. α-functional unsaturated compounds of other suitable structures, such as structures III to X, will react in an analogous way, as illustrated in equations III to X.

7. Polyunsaturated polysulphides: Many types of dithiols which can be used as nucleophiles for displacing leaving groups from one or more α-functional unsaturated compound(s), in which case the linear polymers produced are polyunsaturated polysulfides. Examples of reactions of embodiments of α-functional unsaturated compounds of structure II include, but are not limited to, the reaction shown in equation XXVIII below:
L¹-CR¹R²—CR³═CR⁴—CR⁵R⁶-L²+HS—R²⁶—SH→[—CR¹R²—CR³═CR⁴—CR⁵R⁶—S—R²⁶S]— [XXVIII]
where R²⁶ can be alkyl, cycloalkyl, aryl, or aralkyl. In some embodiments the group R²⁶ may for instance possess a main chain of a length of 2 to about 20 carbon atoms, while in other embodiments one or more polymeric dithiols may be used. The group R²⁶ may also contain other polar, non-polar, saturated or unsaturated groups so long as these groups do not take part in and do not prevent the polymerization reaction. Optionally the group R¹⁸ may be chosen with the intent that it will only slightly or not at all retard the polymerisation reaction. Some of the commonly employed dithiols are: ethane dithiol, propane dithiol, butane dithiol, pentane dithiol, and dithiols of higher homologues, various isomers of benzene dithiols etc. α-functional unsaturated compounds of other suitable structures, such as structures III to X, will react in an analogous way, as illustrated in equations III to X.

8. Polyunsaturated poly tertiary amino ethers: Many types of N-monosubstituted amino alcohols can be used as nucleophiles for displacing halogens from one or more α-functional unsaturated compound(s), in which case the linear polymers produced are polyunsaturated poly tertiary amino ethers. Examples of reactions of embodiments of α-functional unsaturated compounds of structure II include, but are not limited to, the reaction shown in equation IXXX below: 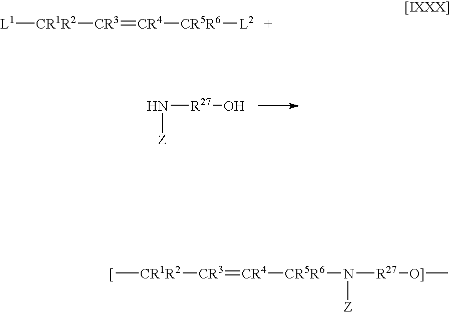
where R²⁷ can be alkyl, cycloalkyl, aryl, or aralkyl. In some embodiments the group R²⁷ may for instance possess a main chain of a length of 2 to about 20 carbon atoms, while in other embodiments one or more polymeric N-monosubstituted amino alcohols may be used. The group R²⁷ may also contain other polar, non-polar, saturated or unsaturated groups so long as these groups do not take part in and do not prevent the polymerization reaction. Optionally the group R²⁷ may be chosen with the intent that it will only slightly or not at all retard the polymerisation reaction. One example for N-monosubstituted amino alcohol is N-methyl ethanol. α-functional unsaturated compounds of other suitable structures, such as structures III to X, will react in an analogous way, as illustrated in equations III to X.

9. Polyunsaturated hydrocarbons: One type of carbon nucleophile, which can be used for displacing leaving groups from one or more α-functional unsaturated compound(s), is a bifunctional metal reagent and the linear polymers produced are polyunsaturated hydrocarbons. Examples of reactions of embodiments of α-functional unsaturated compounds of structure II include, but are not limited to, the reaction shown in equation XXX below:
L¹-CR¹R²—CR³═CR⁴—CR⁵R⁶-L²+M-R²⁸-M→[—CR¹R²—CR³═CR⁴—CR⁵R⁶—R²⁸]— [XXX]
where R²⁸ can be alkyl, cycloalkyl, aryl, or aralkyl with a main chain of a length of 2 to about 20 carbon atoms, and M is a metal-functional group, such as for instance —Li, —Na, —ZnCl, —MgBr, or —SnCl₃. Embodiments of such reactions also include, but are not limited to, cross coupling reactions in the presence of transition metal catalysts. The group R¹⁸ may also contain other polar, non-polar, saturated or unsaturated groups so long as these groups do not take part in and do not prevent the polymerization reaction. Optionally the group R²⁸ may be chosen with the intent that it will only slightly or not at all retard the polymerisation reaction. α-functional unsaturated compounds of other suitable structures, such as structures III to X, will react in an analogous way, as illustrated in equations III to X.

Grignard reagents are for example prepared by reacting magnesium metal with an organic bromocompound. Some of the respective useful organo dibromo compounds are: various isomers of dibromo benzene, dibromo ethane, and the higher homologues etc. These types of cross couplings are carried out by making use of a low valent iron complex as reported by R. Martin et al. (Angew. Chem. Int. Ed. 2004, 43, 3955). Cross coupling reactions in the presence of transition metal catalysts include for instance, but are not limited to, reactions known as Stille couplings, Negishi couplings and Kumada couplings. In a Stille coupling the α-functional unsaturated compound is a bifunctional tin-organic compound (see e.g. Del Valle, L, et al., J. Org. Chem., 1990, 55, 3019-3023). In a Negishi coupling, which is generally nickel- or palladium-catalyzed, the α-functional unsaturated compound is a bifunctional organozinc compound (see e.g. Huo, S, Org. Lett., 2003, 5, 423-425). A respective Kumada Coupling, which is generally nickel-catalyzed, is a reaction of a bifunctional Grignard reagent with an α-functional unsaturated compound (see e.g. Holzer B, Hoffmann R W, Chem. Commun. (Camb), 2003, 6, 732-733).

10. Polyunsaturated hydrocarbons: Other types of carbon nucleophiles that can be used for displacing leaving groups from one or more α-functional unsaturated compound(s) are a bifunctional organoboronic acid, boronate ester, or an organoborane. Similarly to the use of a bifunctional metal reagent the linear polymers produced are polyunsaturated hydrocarbons. Examples of a reaction of embodiments of α-functional unsaturated compounds of structure II include, but are not limited to, the reactions shown in equation XXXI below:
L¹-CR¹R²—CR³═CR⁴—CR⁵R⁶-L²+(OH)₂B—R²⁹—B(OH)₂→[—CR¹R²—CR³═CR⁴—CR⁵R⁶—R²⁹]— [XXXI]
where R²⁹ can be alkyl, cycloalkyl, aryl, or aralkyl with a main chain of a length of 2 to about 20 carbon atoms. Such cross coupling reactions are generally palladium-catalysed. The group R²⁹ may also contain other polar, non-polar, saturated or unsaturated groups so long as these groups do not take part in and do not prevent the polymerization reaction. Optionally the group R²⁹ may be chosen with the intent that it will only slightly or not at all retard the polymerisation reaction. Reactions of this type are known as Suzuki couplings (see e.g. Molander, G A, Bernardi, C R, J. Org. Chem., 2002, 67, 8424-8429). α-functional unsaturated compounds of other suitable structures, such as structures III to X, will react in an analoguos way, as illustrated in equations III to X.

In a further type of cross coupling reaction, which is known as the Hiyama coupling (see e.g. Seganish, W M, DeShong, P, Org. Lett., 2004, 6, 4379-4381), a bifunctional organosilane or a siloxane can be used as a carbon nucleophile. Similarly to the use of for instance bifunctional metal reagents and organoboranes, the linear polymers produced are polyunsaturated hydrocarbons.

11. Polyunsaturated poly ketones: Another type of carbon nucleophile, which can be used for displacing leaving groups from one or more α-functional unsaturated compound(s), is a difunctional 1,3-dithiane. The linear polymers produced after hydrolyzing the dithiane groups are polyunsaturated poly ketones. Examples of reactions of embodiments of α-functional unsaturated compounds of structures II and IV include, but are not limited to, the reactions shown in equations XXXII and XXXIII below: 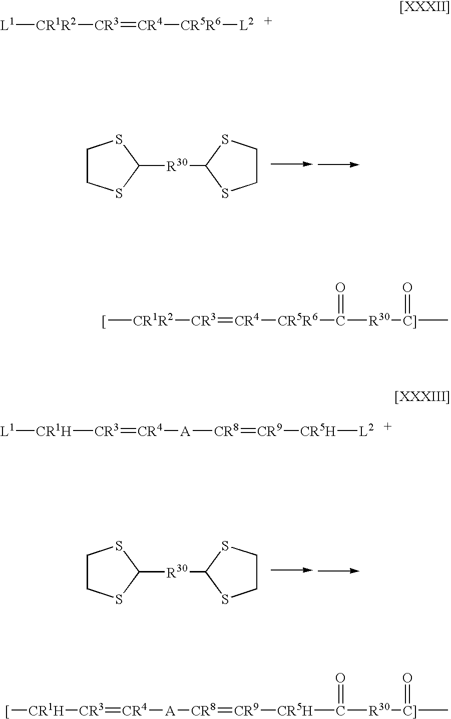
where R³⁰ can be alkyl, cyclic, cycloalkyl, aryl, or aralkyl. In some embodiments the group R³⁰ may for instance possess a main chain of a length of 2 to about 20 carbon atoms, while in other embodiments one or more polymeric difunctional 1,3-dithiane may be used. The group R³⁰ may also contain other polar, non-polar, saturated or unsaturated groups so long as these groups do not take part in and do not prevent the polymerization reaction. Optionally the group R³⁰ may be chosen with the intent that it will only slightly or not at all retard the polymerisation reaction. Dithianes are obtained by reacting dialdehydes with dithiols. Some of the preferred dialdehydes are the isomeric benzene dialdehydes. The suitable dithiols to protect these aldehydes are 1,2-ethane dithiol and 1,3-propane dithiol. α-functional unsaturated compounds of other suitable structures, such as structures III and V to X, will react in an analogous way, as illustrated in equations III and V to X.

As already explained above, (cf. e.g. para 99 et seq), the linear polyunsaturated polymers thus obtained may be modified by means of cross-linking reactions of the terminal leaving groups or nucleophiles, for instance by employing oligofunctional compounds. Various alternative ways of modifying the obtained linear polyunsaturated polymers include the use of the preserved double bonds by methods well known to those skilled in the art. Examples of such modifying reactions include, but are not limited to, a monohalogenation using hydrogen halogenide, a dihalogenation such as the Kondakoff dihalogenation using an elementary halogene, epoxidation as for instance by the Prilezhaev reaction, hydrosilylation using metal catalysts, dihydroxylation by e.g. iodine and silver salts or by Sharpless bishydroxylation using osmium tetroxide, or oxidation to ketones by the Wacker-Hoechst process in the presence of palladium chloride/copper chloride. In the following, non-limiting examples of such modifying reactions shall be illustrated in more detail.

One modification reaction involves the partial or complete reduction of the unsaturated bonds of the polymer by hydrogen in the presence of metals like palladium to yield the corresponding fully saturated or partly unsaturated polymers.

A monohalogenation of the double bonds, as for example disclosed in U.S. Pat. No. 5,414,095, or a dihalogenation, as for example disclosed in U.S. Pat. No. 3,243,480 yields halogenated polymers. Halogenated polymers are useful as flame retardants. Flame retardancy has become a desired property for plastic articles used for commercial and household purposes such as electrical insulation, carpeting, seat covers and the like. Such mono halogenated polymers are the functional polymeric equivalent of polyvinyl chloride (PVC) which is a versatile polymer used in many applications such as water piping, floor tile, exterior vinyl sliding, electrical wire insulation, shower curtains and synthetic leather. PVC is the second largest thermoplastic resin manufactured after polyolefins. These are cited here only as reference. Fluoro substitution will yield novel fluoro polymers. Fluorine containing polymers in general are excellent in heat resistance, chemical resistance, weatherability, surface properties like low friction and electrical insulation. Because of their high resistance to penetration of solvents they are used in tube or pipe lining, for transportation of fuels, paints and chemical liquids. Polyimides containing fluorine atoms exhibit low dielectric constants and hence are very useful as film and coating materials for industrial and aerospace applications where high electrical insulation, moisture resistance, mechanical strength and thermal stability are required.

A further modification, particularly if the backbone of the obtained linear polymer contains silane moieties—which can be achieved by a respective selection of the monomers—involves the hydrosilylation of unsaturated bonds. Hydrosilylation is achieved with alkoxyhydrosilanes or trichlorosilane in the presence of platinum or nickel catalysts. This modification can be used for crosslinking purposes, either within the linear polymer or with additional compounds. It should be observed that keto groups present in the polymer will also be hydrosilylated.

Yet another modification involves the epoxidation of unsaturated bonds. Such epoxides are starting materials for a diverse variety of functional polymers including polyol polymers and polyamino alcohols. Epoxidation can be carried out by reagents such as m-chloro perbenzoic acid as reported by A. Finne et al. (J. Polym. Sci., Part A, Polym. Chem. 42, (2004), 444). An alternative process involves hydrogen peroxide and a silicotungstate compound (see e.g. K. Kamata et al, Science 300, (2003), 964). Epoxides thus obtained may be reacted in a cationic ring opening polymerisation by help of a Lewis acid catalyst (cf. U.S. Pat. No. 5,597,978). Alternatively, obtained epoxides can be reacted with a thiol compound containing a tertiary amine to yield an alcoholic sulphide carrying a tertiary amino group. Quaternary ammonium salts can be prepared by such tertiary amine containing polymer by treating it with halides like benzyl bromide (cf. e.g. X. Lou et al, J. Polym. Sci., Part A, Polym. Chem. 40, (2002), 2286).

Quaternary ammonium salts can also be prepared from the halogenated polymers by heating with tertiary amine bases like pyridine (see e.g. C. Detrembleur et al, Macromolecules 33, (2000), 7751). The linear polymers obtained by following equations XXIV and XXV are also useful for making quaternary ammonium salts by treatment with halides like alkyl or aralkyl chlorides, bromides or iodides. These quaternary ammonium salts have applications as ion exchange resins and also as catalysts for chemical reactions.

One other modification involves the dihydroxylation of unsaturated bonds. Dihydroxylation is achieved either by a mixture of hydrogen peroxide and a sulfonic acid resin as disclosed by Y. Usui et al (Angew. Chem. Int. Ed. 42, (2003), 5623) or by osmium tetroxide as disclosed by M. Minato et al (J. Org. Chem. 55, (1990), 766). Such 1,2-diols are widely used as intermediates in the perfume and fragrance industry, for the manufacturing of cosmetics, for the synthesis of commercial products like photographic materials, lubricants, and in drugs and foods.

A further modification involves the oxidation of unsaturated bonds to ketones by organic hydro peroxides in the presence of water and a metal catalyst at high temperatures as disclosed in U.S. Pat. No. 4,000,200. Such polyketones are useful as plasticizers for polyvinyl chloride.

Another modification involves the oxidation of polyunsaturated polysulfides as obtained by equation XXIII to polysulfones. Such unsaturated polysulfones are useful as recording materials.

One further modification involves the free radical curing of the linear polyunsaturated polymer with a vinyl monomer. Examples of vinyl monomers include, but are not limited to, unsubstituted and substituted vinyl aromatics, vinyl esters of carboxylic acids, acrylates, methacrylates, hydroxyalkyl acrylates, hydroxyalkyl methacrylates, acrylamides, methacrylamides, acrylonitrile, and methacrylonitrile. Preferred vinyl monomers are vinyl aromatics, halogenated vinyl aromatics and methacrylic acid esters. Particularly preferred vinyl monomers are styrene, vinyl toluene and methyl methacrylate. The thermosets thus obtained are often used to form composite materials.

The invention will be further illustrated with reference to the following non limiting examples.

### EXAMPLES

I. Oxygen Nucleophile

### Example 1

### Synthesis of Polyunsaturated Poly Ethers

This example illustrates the synthesis of polyunsaturated poly ethers.

In a single neck 100 ml round bottom flask Bisphenol-A (2.5 g, 0.011 mol) was dissolved in 25 ml DMSO with stirring. Trans-1,4-dibromo-2-butene (2.34 g, 0.011 mol) was added followed by potassium carbonate (3.025 g, 0.022 mol). The reaction mixture was stirred at room temperature for 24 h under N₂ atmosphere. A dense mass was obtained. The contents of the flask were then transferred to a 1 L beaker containing 800 ml of water. The white solid obtained was filtered and dried in air. Yield 2.8 g (91%). The structure was confirmed by ¹H- and ¹³C-NMR of the polymer.

IR (KBr) cm⁻¹: 2966, 1605, 1509, 1442, 1233, 1180, 1013, 830, 556

Thermal analysis (N₂ atmosphere, 10° C./minute): T_{g} 147° C., Exotherm 256° C.

### Example 2

### Synthesis of Polyunsaturated Polyesters

This example illustrates the synthesis of polyunsaturated polyesters.

In a single neck 100 ml round bottom flask fitted with a drying tube, terephthalic acid (1.66 g, 0.01 mol) was dissolved in 25 ml DMAc with stirring. Trans-1,4-dibromo-2-butene (2.14 g, 0.01 mol) was added followed by potassium carbonate (3 g, 0.022 mol). The reaction mixture was stirred at room temperature for 48 h. A dense mass was obtained. The contents of the flask were then transferred to a 1 L beaker containing 800 ml of water. The white solid obtained was filtered and dried in air. Yield 2 g (92%).

IR (KBr) cm⁻¹: 2955, 2877, 2552, 1717, 1504, 1447, 1409, 1382, 1266, 1248, 1119, 1100, 1017, 996, 729, 499.

Thermal analysis (N₂ atmosphere, 10° C./minute): T_{g} 108° C., Tₘ 211° C., Exotherm 322° C.

### Example 3

### Synthesis of Polyunsaturated Polyether Esters

This example also illustrates the synthesis of polyunsaturated polyesters.

In a single neck 100 ml round bottom flask fitted with a drying tube, 4-hydroxy benzoic acid (1.38 g, 0.01 mol) was dissolved in 25 ml DMAc with stirring. Trans-1,4-dibromo-2-butene (2.14 g, 0.01 mol) was added followed by potassium carbonate (3 g, 0.022 mol). The reaction mixture was stirred at room temperature for 48 h. A dense mass was obtained. The contents of the flask were then transferred to a 1 L beaker containing 800 ml of water. The white solid obtained was filtered and dried in air. Yield 1.8 g (95%). The structure was confirmed by ¹H- and C-NMR of the polymer.

IR (KBr) cm⁻¹: 2933, 2873, 1713, 1605, 1507, 1420, 1246, 1167, 1102, 1001, 845, 768, 694.

GPC analysis (Polystyrene standard; THF eluent): Mₙ 37,384; M_{w} 53,232.

Thermal analysis (N₂ atmosphere, 10° C./minute): T_{g} 115° C., Exotherm 284° C.

II. Nitrogen Nucleophile

### Example 4

### Synthesis of Polyunsaturated Poly Tertiary Amines

This example illustrates the synthesis of poly tertiary amines.

piperazine (1.25 g, 0.0145 mol) was dispersed with stirring in 20 ml of DMAc. Potassium carbonate (4.01 g, 0.03 mol) followed by trans-1,4-dibromo-2-butene (3.1 g, 0.0145 mol) was added. An exothermic reaction was observed. A thick mass was obtained after stirring at room temperature for 4 h. The reaction mixture was stirred for an additional 2 h and then transferred into a 1 L beaker containing 800 ml of water. A spongy mass was obtained. Filtered and air dried. Yield 2 g (quantitative).

IR (KBr) cm⁻¹: 3439, 2941, 2830, 1653, 1459, 1360, 1315, 1124, 983, 873.

Thermal analysis (N₂ atmosphere, 10° C./minute): Exotherm 280° C.

### Example 5

### Synthesis of Polyunsaturated Polyimides

This example illustrates the synthesis of polyunsaturated polyimides.

Preparation of Diimide Monomer

4,4′-(4,4′-Isopropylidene diphenoxy)bis(phthalic anhydride) (5 g, 0.01 mol) was suspended in 25 ml glacial acetic acid. Ammonia solution (28%, 30 ml) was added dropwise over 30 minutes during which period a light yellow coloured solution was obtained. The solution was stirred at room temperature for an additional 30 minutes and then refluxed overnight. After cooling, the reaction mixture was poured into large excess of water. A white coloured solid was obtained. The solid was filtered and air dried. Yield 3 g (60%). The structure was confirmed by ¹H- and ¹³C-NMR.

IR (KBr) cm⁻¹: 3258, 3069, 2971, 1769, 1718, 1600, 1501, 1476, 1364, 1312, 1271, 1234, 1168, 1086, 1040, 927, 837, 749, 646.

Thermal analysis (N₂ atmosphere, 10° C./minute): Tₘ 248° C.

Preparation of Polyimide

The above diimide (2 g, 0.004 mol) and potassium t-butoxide (0.865 g, 0.008 mol) were heated at 110° C. in a solvent mixture of 25 ml of DMAc and 10 ml of hexane in a flask fitted with the Dean-Stark apparatus overnight under nitrogen atmosphere. After removing the hexane completely, the flask was cooled down to room temperature. Trans-1,4-dibromo-2-butene (0.82 g, 0.004 mol) was then added and the mixture was stirred at room temperature for 48 h. Then the reaction mixture was poured into 800 ml of water in a 1 L beaker. A white coloured solid was obtained which was filtered and air dried. Yield 2 g (91%). The structure was confirmed by H— and ¹³C-NMR of the polymer.

IR (KBr) cm⁻¹: 2967, 2934, 1773, 1711, 1623, 1600, 1503, 1476, 1443, 1391, 1360, 1272, 1233, 1173, 1097, 1080, 1014, 947, 905, 841, 748, 544.

GPC analysis (Polystyrene standard; THF eluent): Sparingly soluble in THF. Peak molecular weight of the soluble portion was 10,167.

Thermal analysis (N₂ atmosphere, 10° C./minute): T_{g} 186° C., 5 weight % loss at 410° C.

III. Nitrogen and Oxygen Nucleophiles

### Example 6

### Synthesis of Polyunsaturated Polytertiary Amino Ethers

This example illustrates the synthesis of polyunsaturated polytertiary amino ethers.

N-Methyl amino ethanol (0.751 g, 0.01 mol) diluted with 10 ml dichloromethane was added dropwise to a solution of trans-1,4-dibromo-2-butene (2.14 g, 0.01 mol) in dichloromethane (30 ml) and potassium carbonate (3 g, 0.022 mol). The mixture was stirred at room temperature for 24 h. A sticky white solid settled at the bottom of the flask. Dichloromethane was decanted off. Concentrated hydrochloric acid was added dropwise cautiously to neutralise the remaining base. After making the residue slightly acidic, the solid was filtered off and washed with acetone. The moist solid was dried in a vacuum oven for two days at room temperature. Yield 1.2 g (94%). The structure was confirmed by ¹H- and ¹³C-NMR of the polymer.

Thermal analysis (N₂ atmosphere, 10° C./minute): Exothem 210° C.

IV. Sulphur Nucleophile

### Example 7

### Synthesis of Polysulphides

This example illustrates the synthesis of polysulphides.

A mixture of 1,2-ethane dithiol (1.12 g, 0.012 mol) and trans-1,4-dibromo-2-butene (2.54 g, 0.012 mol) was stirred in 25 ml DMAc. Potassium carbonate (3.3 g, 0.024 mol) was then added and the stirring continued for 48 h. The reaction mixture was then poured into 800 ml of water in a 1 L beaker. The off white solid separated was filtered and air dried. Yield 1.6 g (92%). The structure was confirmed by ¹H- and ¹³C-NMR of the polymer.

IR (KBr) cm⁻¹: 3016, 2911, 1414, 1194, 1121, 964, 878, 719, 677, 436.

Thermal analysis (N₂ atmosphere, 10° C./minute): Tₘ 105° C., Exotherm 256° C.

What is claimed is:

1. A process for preparing a modifiable linear polyunsaturated polymer comprising reacting solely at least one bifunctional nucleophilic compound with at least one α-functional unsaturated monomer,
wherein said at least one bifunctional nucleophilic compound comprises two nucleophiles independently selected from the group consisting of C, N, O, S and Se, wherein the at least one α-functional unsaturated monomer comprises at least two leaving groups L¹ and L²,
wherein at least one of the leaving groups L¹ and L² of the at least one α-functional unsaturated monomer is part of the nonaromatic unsaturated structure C═C—C_{α}-L, and
wherein the double bond of said at least one unsaturated monomer is maintained in the linear polyunsaturated polymer.

2. The process of claim 1, wherein the at least one α-functional unsaturated monomer is a compound of any of formulas I to IX:
L¹-CR¹-R²—CR³═CR⁴—CR⁵R⁶-L² [FORMULA I], 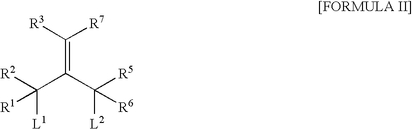
L¹-CR¹-R²—CR³═CR⁴-A-CR⁸═CR⁹—CR⁵R⁶-L² [FORMULA III], 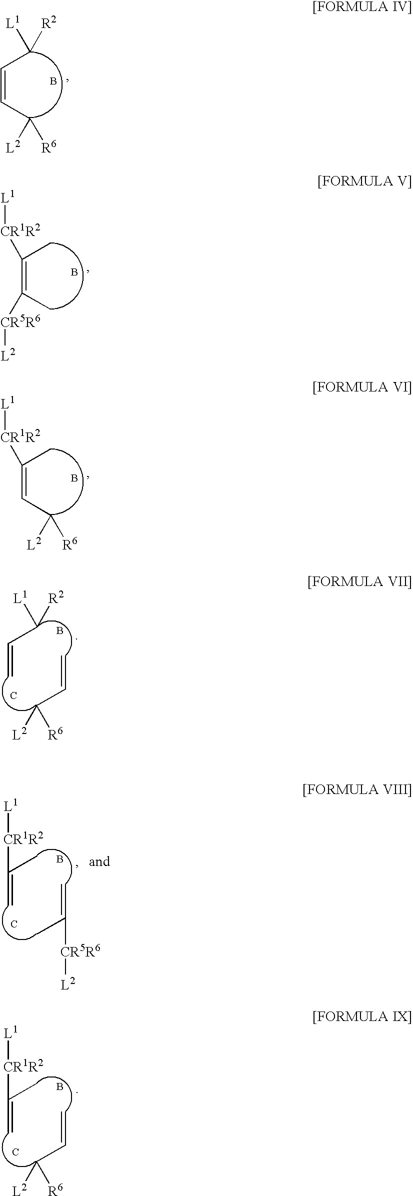
wherein L¹ and L² are independently selected suitable leaving groups; R¹ in formulas I, II, III, V, VI, VIII and IX, R² in formulas I to IX, R³ in formulas I to III, R⁴ in formulas I and III, R⁵ in formulas I to III, V and VIII, R⁶ in formulas I to IX, R⁷ in formula II, R⁸ and R⁹ in formula III are independently selected from the group consisting of H, aliphatic, cycloaliphatic, aromatic, arylaliphatic, and arylcycloaliphatic hydrocarbyl groups, comprising 0 to about 3 heteroatoms selected from the group N, O, S, Se and Si, and may also be F (fluorine) as long as L¹ and L² are different from F;
A in formula III may be a) absent, b) a heteroatom selected from the group N, O, S, Se and Si, or c) may be selected from the group consisting of aliphatic, cycloaliphatic, aromatic, arylaliphatic and arylcycloaliphatic radical;
and B in formulas IV to IX as well as C in formulas VII to IX are an aliphatic bridge comprising 1 to about 12 carbon atoms, completing the non-aromatic ring of formulas IV to IX, and VII to IX respectively.

3. The process of claim 1, wherein the leaving groups L¹ and L² are independently from one another selected from the group consisting of halogen, cyano, thiocyano, trifluoromethyl sulfonyl, p-toluenesulfonyl, bromobenzenesulfonyl, nitrobenzenesulfonyl, methanesulfonyl and azido.

4. The process of claim 2, wherein the at least one α-functional unsaturated monomer is selected from the group consisting of 1,4-dihalobuten, 1,4-dithiocyanobuten, 1,4-dihalo-2-pentene, 2,5-dihalo-3-hexene, 1,11-dibromo-2,9-undecadiene, 1,10-Dibromo-2,8-decadiene, 1,9-Dichloro-2,7-nonadiene, 1,12-Dibromo-2,10-dodecadiene, 3,4-bis(methylene)-hexanedinitrile, (1,4-dihalo-2-butenyl)trimethylsilane, 2-(trimethylsilyl)-2-hexenedinitrile, 1,1′-thiobis[4-halo-2-butene], 1,6-dihalohexa-2,4-dien, 1,8-dihaloocta-2,4,6-trien, 1,2-bis(halomethyl)-1,4-cyclohexadiene, 1,4-dihalocyclohex-2-ene, 1,4-dithiocyano-2-cycloocta-2-en, 3,7-dihalo-1,5-cyclooctadiene, 1,4-dihalo-1,3a,4,6a-tetrahydro-3a,6a-dimethyl-pentalene, 1,4-dihalo-1,4,4a,5,8,8a-hexahydronaphthalene, 1,5-dihalo-1,4,4a,5,8,8a-hexahydro-naphthalene and 2,3-bis(halomethyl)-1,4-dihydronaphthalene.

5. The process of claim 1, wherein the at least one bifunctional nucleophilic compound is selected from the group consisting of aliphatic, cycloaliphatic, aromatic, and arylaliphatic compounds, wherein the nucleophiles are comprised in functional groups, which are independently selected from the group consisting of amino-, amido-, carboxyl-, hydroxyl-, seleno-, thio-, dithiol protected aldehyde-, organometal-, organoboron-, and dithiane groups.

6. The process of claim 1, wherein the polymerisation reaction is performed in a solvent selected from the group consisting of hexane, heptane, carbon disulfide, benzene, toluene, p-xylene, pyridine, aniline, butyl alcohol, phenol, chlorophenol, dichloromethane, chloroform, carbon tetrachloride, tetrahydrofuran, methyl ethyl ketone, methyl isobutyl ketone, acetone, cyclohexanone, ethyl acetate, isobutyl isobutyrate, ethylene glycol diacetate, dimethylarsinic acid, dioxane, diethyl ether, diisopropylether, ethylene glycol monobutyl ether, tetrahydrofuran, dimethylformamide, acetonitrile, dimethyl acetamide, nitromethane, acetonitrile, N-methylpyrrolidone, and dimethylsulfoxide.

7. The process of claim 1, wherein the polymerisation reaction is performed in the presence of a catalyst of the group of Brønstedt acids, Brønstedt bases, Lewis acids and Lewis bases.

8. The process of claim 7, wherein the Brønstedt base is selected from the group consisting of calcium hydroxide, potassium hydroxide, sodium hydroxide, potassium carbonate, sodium carbonate, lithium carbonate, caesium carbonate, calcium carbonate, potassium t-butoxide, n-butyl lithium, sec-butyl lithium, lithium diisopropyl amide and phenyldimethylsilyllithium.

9. The process of claim 1, where the polymerisation reaction is performed at about −20° to about 110° C.

10. The process of claim 9, where the polymerisation reaction is performed at about 0° to about 70° C.

11. The process of claim 9, where the polymerisation reaction is performed at about 20° to about 25° C.

12. The process of claim 1, further comprising modifying the obtained linear polyunsaturated polymer.

13. A linear modifiable polyunsaturated polymer obtainable by a process comprising reacting solely at least one bifunctional nucleophilic compound with at least one α-functional unsaturated monomer, wherein said at least one bifunctional nucleophilic compound comprises two nucleophiles selected from the group consisting of C, N, O, S and Se, wherein the at least one α-functional unsaturated monomer comprises at least two leaving groups L¹ and L², and wherein at least one of the leaving groups L¹ and L² of the at least one α-functional unsaturated monomer is part of the nonaromatic structure C═C—C_{α}-L.

14. A linear modifiable polyunsaturated polymer according to claim 13, wherein the at least one α-functional unsaturated monomer is a compound of any of formulas I to IX:
L¹-CR¹R²—CR³═CR⁴—CR⁵R⁶-L² [FORMULA I], 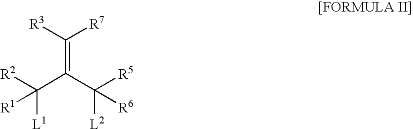
L¹-CR¹R²—CR³═CR⁴-A-CR⁸═CR⁹—CR⁵R⁶-L² [FORMULA III], 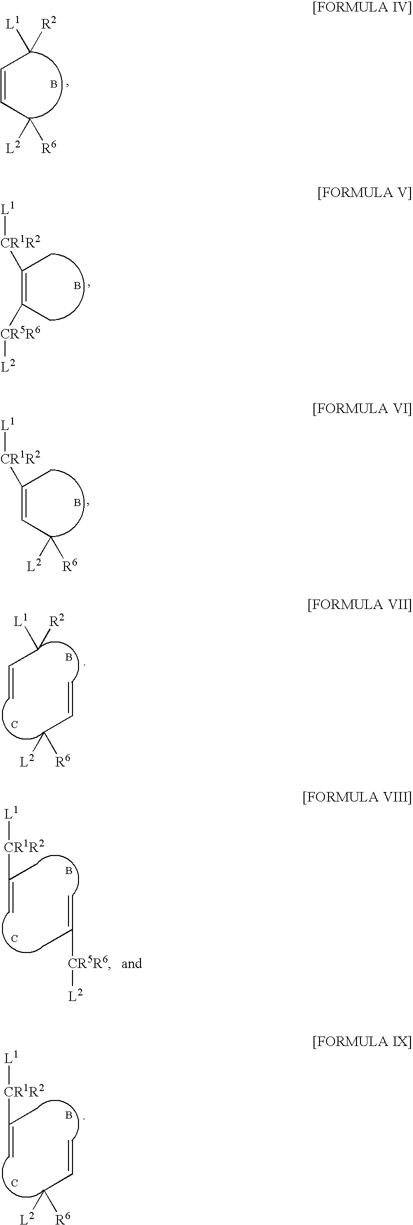
wherein L¹ and L² are independently selected suitable leaving groups;
R¹ in formulas I, II, III, V, VI, VIII and IX, R² in formulas I to IX, R in formulas I to III, R⁴ in formulas I and III, R⁵ in formulas I to III, V and VIII, R⁶ in formulas I to IX, R⁷ in formula II, R⁸ and R⁹ in formula III are independently selected from the group consisting of H, aliphatic, cycloaliphatic, aromatic, arylaliphatic, and arylcycloaliphatic hydrocarbyl groups, comprising 0 to about 3 heteroatoms selected from the group N, O, S, Se and Si, and may also be F (fluorine) as long as L¹ and L² are different from F;
A in formula III may be a) absent, b) a heteroatom selected from the group N, O, S, Se and Si or c) may be selected from the group consisting of aliphatic, cycloaliphatic, aromatic, arylaliphatic and arylcycloaliphatic radical;
and B in formulas IV to IX as well as C in formulas VII to IX are an aliphatic bridge comprising 1 to about 12 carbon atoms, completing the non-aromatic ring of formulas IV to IX, and VII to IX respectively.

15. The linear modifiable polyunsaturated polymer according to claim 13, wherein the leaving groups L¹ and L² are selected from the group consisting of halogen, cyano, thiocyano, trifluoromethyl sulfonyl, p-toluenesulfonyl, bromobenzenesulfonyl, nitrobenzenesulfonyl and methanesulfonyl.

16. The linear modifiable polyunsaturated polymer according to claim 13, selected from the group consisting of polyunsaturated polytertiary amines, polyunsaturated polyamides, polyunsaturated polyimides, polyunsaturated polyesters, polyunsaturated polyether esters, polyunsaturated hydrocarbons, polyunsaturated polyketones, and polyunsaturated polytertiary amino ethers.

17. The linear modifiable polyunsaturated polymer according to claim 13, wherein the linear polyunsaturated polymer is modified by a reaction of the group consisting of reactions of the double bonds, reactions of further moieties originating from moieties of the at least one bifunctional nucleophilic compound, reactions of further moieties originating from moieties of the at least one α-functional unsaturated monomer, and reactions involving the terminal leaving groups.

18. The linear modifiable polyunsaturated polymer according to claim 17, wherein the reaction of the terminal leaving groups comprises a cross-linking-reaction.

19. The linear modifiable polyunsaturated polymer according to claim 17, wherein the reaction of the double bond comprises a reaction of the group consisting of reduction, oxidation, and curing.

20. The linear modifiable polyunsaturated polymer according to claim 19, wherein the reduction comprises a reaction of the group consisting of hydrogenation and hydrosilylation.

21. The linear modifiable polyunsaturated polymer according to claim 19, wherein the oxidation comprises a reaction of the group consisting of epoxidation, dihydroxylation, monohalogenation, dihalogenation, and oxidation to ketones by organic hydro peroxides.

22. The linear modifiable polyunsaturated polymer according to claim 19, wherein the curing comprises a reaction of the group consisting of free radical, thermal, and photochemical reactions, optionally in the presence of vinyl monomers.
